(19) United States
(12) Patent Application Publication
(10) Pub. No.: US 2025/0386029 A1
(43) Pub. Date: Dec. 18, 2025

(54) CONSTANT RATE FACTOR VIDEO ENCODING CONTROL

(71) Applicant: V-NOVA INTERNATIONAL LIMITED, London (GB)

(72) Inventors: Lorenzo CICCARELLI, London (GB); Guido MEARDI, London (GB)

(21) Appl. No.: 19/141,519

(22) PCT Filed: Dec. 20, 2023
(86) PCT No.: PCT/GB2023/053320

§ 371 Date: Jun. 20, 2025

(30) Foreign Application Priority Data
Dec. 21, 2022 (GB) 2219332.0
Jun. 7, 2023 (GB) 2308476.7

(51) Int. Cl. H04N 19/147; H04N 19/124; H04N 19/172; H04N 19/33

(52) U.S. Cl. CPC H04N 19/147; H04N 19/124; H04N 19/172; H04N 19/33

(57) ABSTRACT

A method of computing encoding parameters for an encoding of an input video is described. The method may be seen as a form of constant rate factor control for a multi-layer coding scheme. The method includes receiving an encoding quality factor indicating a desired visual quality for an encoding of the input video. The encoding quality factor is mapped to a base quality factor indicating a desired visual quality for a base encoding of the input video, the base encoding providing an encoding at a first level of quality. Base encoding parameters are obtained from a base encoder. The encoding quality factor, base quality factor, and base encoding parameters are mapped to enhancement encoding parameters for an enhancement encoding, wherein a combination of the base encoding and the enhancement encoding provide an encoding at a second level of quality that is higher than the first level of quality. Also, two modes for constant rate factor control are described. In a “charging” mode, an encoding quality factor is selectively modulated based on characteristics of the input video. In an “accurate” mode, an encoding quality factor is selectively recomputed based on encoding parameters.

### TECHNICAL FIELD

This disclosure relates to a method for encoding video data. In particular, but not exclusively, this disclosure relates to an encoding control methodology for a multi-layer video coding scheme, whereby encoding is controlled based on a constant rate factor that represents a desired video quality for a decoded output.

### BACKGROUND

When encoding data, for example video data, it is known to control the number of bits required to encode a portion of the data. In the case of video data, this may be the number of bits to encode a frame of video data. The control of the number of bits required is known as rate control. It is known to set the bit rate at a constant, or variable value.

The most common form of rate control is known as “Constant Bit Rate”, or CBR, encoding whereby a target bit rate, e.g. in kilobytes or megabytes per second for an encoded video stream, is supplied as an input parameter for an encoding process. The encoding process then aims to achieve the target bit rate over a set of encoded frames. For the encoding, an average bit rate may be constrained to be within a particular tolerance range of the target bit rate.

“Variable Bit Rate”, or VBR, encoding is a variation of CBR encoding. In this case, a bit rate is allowed to vary during encoding. For example, the bit rate may be allowed to vary within a defined range supplied as an input parameter based on the complexity of different scenes, with more complex scenes having a bit rate towards the maximum of the defined range and with less complex scenes having a bit rate towards the minimum of the defined range.

Another known form of rate control uses a “Constant Rate Factor”, or CRF. In this case, the data rate is adjusted to achieve, or maintain, a desired visual quality of the encoding. For encoding, the encoder chooses the bit rate to meet the desired quality and the bit rate may increase or decrease depending on the complexity of the scene to be encoded. For example, a more complex scene will require more data to encode a given level of quality than a less complex scene at the same level of quality. Thus, CRF encoding aims to maintain a constant level of visual quality when encoding, compared to maintaining a constant bitrate as is found in constant bitrate encoding.

A variation of CRF encoding is capped CRF encoding. In this case, a CRF is used as above but a further maximum bit rate constraint is provided. For example, a user may supply a maximum bit rate as an input and an encoder encodes the video in a CRF mode while attempting not to exceed the maximum bit rate.

The encoding modes described above may be set as encoding parameters in popular encoder implementations. For example, the cross-platform software encoder ffmpeg has options to set the above modes and ranges as command line input parameters when encoding using H.264 (AVC), H.265 (HEVC) or VP9 encoders.

Much of the video content on the Internet is encoded using well-established single-layer video coding schemes such as H.264 (also known as MPEG-4 Part 10, Advanced Video Coding—MPEG-4 AVC). For example, this format is used for between 80-90% of online video content. In a single-layer approach, content is encoded by a single monolithic encoder architecture. The encoded content is then supplied to decoding devices as a single video stream that has a one-to-one relationship with available hardware and/or software video decoders, e.g. a single stream is received, parsed, and decoded by a single video decoder to output a reconstructed video signal.

Within this context, multi-layer video coding schemes have existed for a number of years but have experienced problems with widespread adoption. Multi-layer coding schemes include the Scalable Video Coding (SVC) extension to H.264, Scalable extensions to H.265 (MPEG-H Part 2 High Efficiency Video Coding—SHVC), and newer standards such as MPEG-5 Part 2 Low Complexity Enhancement Video Coding (LCEVC). While H.265 is a development of the coding framework used by H.264, LCEVC takes a different approach to scalable video. SVC and SHVC operate by creating different encoding layers and feeding each of these with a different spatial resolution. Each layer encodes the input according to a normal AVC or HEVC encoder with the possibility of leveraging information generated by lower encoding layers. LCEVC, on the other hand, generates one or more layers of enhancement residuals as compared to a base encoding, where the base encoding may be of a lower spatial resolution.

One reason for the slow adoption of multi-layer coding schemes has been the difficulty adapting existing and new encoders and decoders to process multi-layer encoded streams. As discussed above, video streams are typically single streams of data that have a one-to-one pairing with an input “raw” data stream. Hence, the convention is to pass a file to be encoded to a tool such as ffmpeg, together with command line parameters that provide rate control. Within this framework, multi-layer schemes such as SVC and SHVC have typically been implemented as if they were larger single video streams. However, this reduces the flexibility of multi-layer schemes to use varying base encodings. SVC and SHVC encodings also typically implement CBR-based approaches, where a target bit rate for the multi-layer stream may be distributed across the multiple layers within the stream (e.g., in a simple case by dividing by the number of layers).

As background, the paper “The Scalable Video Coding Extension of the H.264/AVC Standard” by Heiko Schwarz and Mathias Wien, as published in IEEE Signal Processing Magazine 135, March 2008, provides an overview of the SVC extension. The paper “Overview of SHVC: Scalable Extensions of the High Efficiency Video Coding Standard” by Jill Boyce, Yan Ye, Jianle Chen, and Adarsh K. Ramasubramonian, as published in IEEE Transactions on Circuits and Systems for Video Technology, VOL. 26, NO. 1, January 2016, then provides an overview of the SHVC extensions.

The decoding technology for LCEVC is set out in the Draft Text of ISO/IEC FDIS 23094-2 as published at Meeting 129 of MPEG in Brussels in January 2020, as well as the Final Approved Text and WO 2020/188273 A1.

US 2013/0322524 A1 describes a rate control method for multi-layered video coding. In the rate control method for multi-layered video coding, encoding statistical information is generated based on the result of encoding input video data on a first layer. A second rate controller generates a plurality of quantization parameters to be used when encoding is performed on a second layer, based on the encoding statistical information and/or region of interest (ROI) information. Target numbers of bits that are to be respectively assigned to regions of a second layer are determined based on the encoding statistical information and/or ROI information, and the input video data is encoded at the second layer, based on the target numbers of bits.

US 2013/0322524 A1 describes a CBR form of base and enhancement encoding. Target bit rates are provided for base and enhancement layers and quantization parameters for the enhancement layer are determined based on a second target bit rate for the second layer and encoding statistical information from the base layer. US 2013/0322524 A1 does not describe adaptations for CRF encoding of base and enhancement video streams.

EP3381187A1 describes a system for encoding a sequence of frames of a data signal. The system comprises a first encoding system comprising at least a first encoder configured to encode the sequence of frames according to a first encoding algorithm and a first rate control unit configured to control a first bit rate at which the first encoder encodes said sequence of frames. The system also comprises a second encoding system comprising at least a second encoder configured to encode a second sequence of frames associated with the sequence of frames according to a second encoding algorithm and a second rate control unit configured to control a second bit rate at which the second encoder encodes said second sequence of frames associated with the sequence of frames. Like US 2013/0322524 A1, EP3381187A1 describes a Constant Bit Rate (CBR) encoding functionality. As such, it discloses the use of filler values to maintain the CBR.

Yang et al., in their paper “Rate Control of H.264/AVC Scalable Extension”, IEEE TRANSACTIONS ON CIRCUITS AND SYSTEMS FOR VIDEO TECHNOLOGY, INSTITUTE OF ELECTRICAL AND ELECTRONICS ENGINEERS, US, vol. 18, no. 1, 1 Jan. 2008, pages 116-121, XP011195135, present a rate control scheme for H.264/AVC scalable extension (SVC). A switched model is proposed to predict the mean absolute difference (MAD) of the residual texture from the available MAD information of the previous frame in the same layer and the same frame in its “base layer”. A bit allocation scheme is proposed for the hierarchical B frames structure that takes into consideration the relative importance of each frame. It is noted that this paper states that at the time of writing there was no rate control mechanism in the JSVM reference software. It references a prior method of determining a target bitrate for each layer by coding each layer with a fixed quantisation parameter. The taught method for target rate bit control is specific to the H.264/AVC scalable extension coding methods.

EP3942809 A1 describes a rate controller for encoding a hybrid video stream. In FIG. 5 of this document, a rate controller receives an indication of a desired quality level for the encoding. This indication may be a CRF. The rate controller is configured to convert the indication into control instructions for an enhancement rate controller and base parameters for a base codec. The enhancement rate controller may receive the indication of the desired quality level and determine quantisation parameters for multiple enhancement layers. The base parameters may comprise one or more of a base mode (such as constant bit rate, variable bit rate or constant quality factor modes), a base bit rate, a base buffer size and a maximum base bit rate. The rate controller thus sets the bit rates for the hybrid streams so as to meet or aim for the indication of a desired quality level. In a preferred case, the indication of a desired quality level is static for an encoding of a supplied video signal or file, e.g. is used to encode the video. By way of a quality controller, one or more of the underlying control parameters, including the quantisation parameters Q1 and Q2 may (and will likely) vary from frame to frame to attempt to meet the desired quality level.

In EP3942809 A1, the rate controller for the hybrid video encoding outputs base parameters and quantisation parameters based on the indication of a desired quality level. The rate controller may optionally receive encoding feedback as input, which may comprise one or more of feedback from enhancement level encoding operations or sub-operations, feedback from encoding one or more previous frames or blocks of the video signal, or feedback from the base layer.

However, EP3942809 A1 does not describe in detail how to convert the indication into control instructions for an enhancement rate controller and base parameters for a base codec.

### SUMMARY

Aspects of the present invention, and variations, are set out in the appended claims.

### BRIEF DESCRIPTION OF THE DRAWINGS

One or more examples will now be described with reference to the accompanying drawings, in which:

FIG. 1 shows a schematic diagram of a quality factor calculator according to a first example;

FIG. 2 shows a schematic diagram of a quality factor calculator according to a second example;

FIG. 3 shows a flow diagram setting out an example method of computing encoding parameters for an encoding of an input video;

FIG. 4 shows a schematic diagram of an enhancement rate controller according to an example;

FIGS. 5 and 6 are schematic diagrams respectively showing an example multi-layer encoder and decoder configuration;

FIG. 7 is a schematic diagram showing certain data processing operations performed by an example multi-layer encoder; and

FIG. 8 is a simplified graph showing an example mapping function for determining a base quality factor.

### DETAILED DESCRIPTION

Examples described herein provide an improved method for computing rate control parameters when encoding a video signal using a multi-layer encoding. The examples allow differing base and enhancement video coding approaches while retaining encoding control interfaces that are used for conventional single-layer encodings. By providing a simple interface to encode video with base and enhancement layers, wider adoption of multi-layer encoding approaches is facilitated. Multi-layer encoding approaches provide a flexible way of managing large-scale networks of heterogeneous devices and of implementing video distribution systems in areas with varying network capacity. Multi-layer encoding approaches also allow efficient reuse of existing video encoding technology while providing for developments in display technologies.

Certain examples described herein act to encode a signal into a set of one or more data streams, i.e. data that changes over time. Certain examples relate to an encoder or encoding process that generates a set of streams including at least an enhancement stream, where the enhancement stream provides enhancement to a base stream. The base stream may comprise an encoding with MPEG standards such as AVC/H.264, HEVC/H.265, etc. as well as algorithms such as VP9, AV1, and others. The enhancement stream may comprise an LCEVC stream. It is worth noting that the base stream may be decodable by a hardware decoder while the enhancement stream may be suitable for a software processing implementation with suitable power consumption. Certain examples provide an encoding structure that creates a plurality of degrees of freedom that allow great flexibility and adaptability in many situations, thus making the coding format suitable for many use cases including over-the-top (OTT) transmission, live streaming, live UHD broadcast, and so on. It also provides for low complexity video coding.

In the examples described herein, a CRF-based rate control method for a multi-layer stream is presented. A single encoding quality factor for a video to be encoded (e.g., a CRF for the video) may be passed to an enhancement encoder and converted into quality factors for a base layer and an enhancement layer. The quality factor for the base layer may be determined for the video and per-frame quality factors may be determined for the enhancement layer based on encoding parameters received from a base encoder. These per-frame quality factors may then be used to output enhancement encoding parameters. The enhancement encoder is thus able to adapt the enhancement encoding based on properties of the base encoding to achieve a desired quality level. Using a single encoding quality factor for both layers allows the enhancement encoder to emulate the visual quality range of existing single-layer encoders such as H.264 or H.265 encoders.

It has been found that many existing scalable frameworks have no or limited support for CRF-based rate control. Currently, many implementations simply provide a simple CBR-based approach where an available bit rate is split (typically evenly) between different layers. However, the inventors of the present examples have found that there are complex non-linear relationships between the encoding parameters that are used for different layers (and sublayer) of a multi-layer scheme. By suitably configuring how CRF-based rate control is performed, more efficient multi-layer encodings with higher visual quality for a given bit rate may be achieved.

Certain variations described herein respectively provide “charging” and “accurate” modes for encoding.

In a “charging” mode, an encoding quality factor may be selectively modulated (e.g., “charged” up or down) based on characteristics of the input video to improve encoding efficiency and/or perceived quality following decoding. For example, the encoding quality factor may be modulated to lower a quantisation step width for encoding certain frames, such as those with a higher static content. This may be of benefit when a temporal mode is used that computes an additional residual between frames in a video sequence (e.g., a residual of a residual). By increasing accuracy for frames with static portions, these frames may be used as an accurate temporal reference and thus reduce the number of bits needed to encode subsequent frames (e.g., said subsequent frames being encoded as a temporal difference with respect to the temporal reference).

In an “accurate” mode, an encoding quality factor may be selectively recomputed based on encoding conditions. For example, an initially-computed encoding quality factor may be selectively re-computed for a re-encoding based on a detected change in video content complexity. In certain cases, an “accurate” mode may be considered as a conditional multi-pass encoding system. In this case, within normal operation, a single encoding pass may be used for efficiency. However, a further encoding pass is possible to react to sudden changes in content. The “accurate” mode may help remove spikes within encoded residual values and/or mitigate errors in parameter estimation. The encoding quality factor may be adjusted and/or scaled responsive to a defined condition being met.

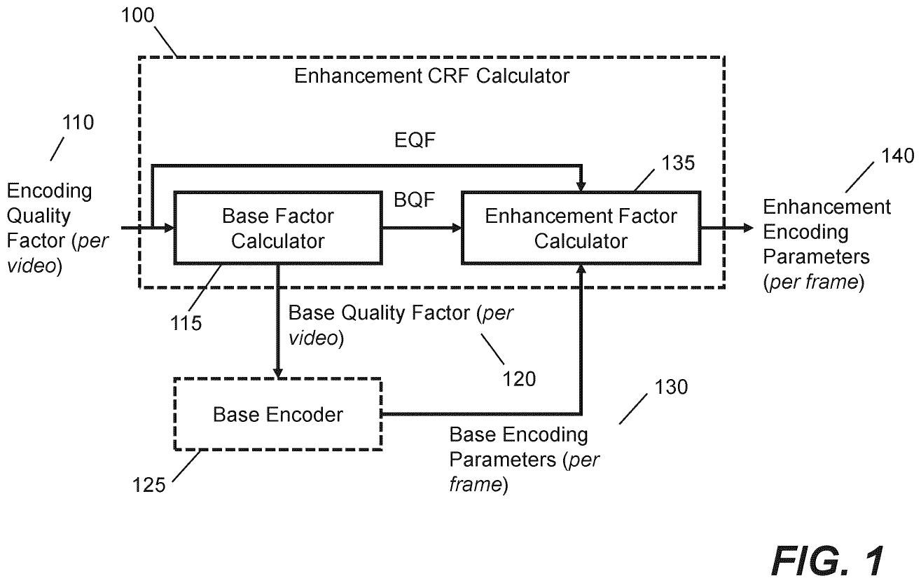

FIG. 1 shows an example enhancement CRF calculator 100 that may be used to calculate encoding parameters for base and enhancement encoding. The example enhancement CRF calculator 100 may form part of an enhancement encoder (e.g., an LCEVC encoder). An example framework for an enhancement encoder is described in WO2022/023747 A1. The enhancement CRF calculator 100 may be implement in hardware (e.g., as part of an application-specific integrated circuit-ASIC-implementation of the enhancement encoder), and/or software (e.g., as part of an encoding tool programmed in a suitable language such as C that is configured to be executed by a processor). The enhancement CRF calculator 100 receives an encoding quality factor 110 for a video to be encoded using a multi-layer scheme. For example, the encoding quality factor 110 may be passed as a parameter (e.g., to a function or as a command line parameter) and/or defined within a configuration file for the encoding. The encoding quality factor 110 may comprise a single integer or floating-point value within a defined range. The defined range may emulate a range used by existing single layer video encoding schemes. For example, H.264 encoders may use a range of 0 to 51 and VP9 may use a range of 4 to 63. Hence, the encoding quality factor 110 may comprise a 6-bit unsigned integer with a range of 0 to 63. In other implementations, the encoding quality factor 110 may comprise an n-bit integer (e.g., where n=8 or 16) or a float (e.g., a normalised value within a range of 0 to 1 or a value within a range of 0 to 61). The encoding quality factor 110 acts as a CRF for the multi-layer video encoding. It thus represents a desired visual quality in a decoding of the multi-layer video encoding where a decoded base stream is combined with a decoded enhancement stream. Lower values of the encoding quality factor 110 may represent a higher decoded output quality and higher values of the encoding quality factor 110 may represent a lower decoded output quality. A value of 0 may represent a completely lossless encoding and a value of 51 or 63 may represent the worst possible visual quality. A mid-range value may be chosen as a default (23 is used as a default for H.264, 28 is a default for H.265 and 31 is a recommended starting value for VP9). The encoding quality factor 110 may vary in a non-linear manner with perceived visual quality of a decoded output. The worst possible visual quality may be mapped to a particular set of values for one or more visual quality metrics.

In FIG. 1, the encoding quality factor 110 is received by a base factor calculator 115 that forms part of the enhancement CRF calculator 100. The base factor calculator 115 maps the encoding quality factor 110 to a base quality factor 120 for a base encoder 125. The base factor calculator 115 may be configured to determine a base encoding type (e.g., a particular base encoding standard such as H.264, H.265, VVC or VP9). This may be performed by determining the type of the base encoder that is being used for the multi-layer encoding. The base encoder may be selected by a parameter passed to the enhancement encoder (e.g., as a command line parameter or via a configuration file). The base encoding type may be selected from a plurality of different available base encoding types representing available base encoders that can be used for the base encoding. For example, these may be base encoders that are registered with the enhancement encoder and/or that are available via an operating system of an implementing computing device. The base factor calculator 115 implements a calculation to convert the encoding quality factor 110 to the base quality factor 120, where this calculation may be specific to the base encoding that is being used for the particular multi-layer encoding. The calculation may be defined as a mathematical function of the encoding quality factor 110. The function may be a linear or non-linear function. Different functions may be defined for different base encoders and appropriately retrieved based on base encoding type. Alternatively, the calculation may be based on a table lookup (with interpolation and/or integer rounding as required), where different tables or rows may be provided for different base encodings. For example, a calculation for an H.264 or H.265 base encoder may map the encoding quality factor 110 to a base quality factor 120 within the range of 0 to 51 and for a VP9 base encoder may map the encoding quality factor 110 to a base quality factor 120 within the range of 4 to 63. The base factor calculator 115 allows an encoding quality factor 110 to be mapped to different base quality factors, where the ranges and values for each base encoding may differ. For example, if the encoding quality factor 110 is set as a 6-bit integer, a value of 31 may be mapped to a base quality factor 120 value of 31 for a VP9 base encoder but to a base quality factor 120 of 23 for an H.264 or H.265 base encoder. The mapping performed by the base factor calculator 115 may be based on empirical observations and/or measurements.

In certain cases, the encoding quality factor 110 may be mapped to a higher or lower base quality factor 120 depending on the encoding configuration. For example, as the base encoding may be corrected and enhanced by the enhancement encoding, the base encoder may be able to use a lower CRF value than that provided by the encoding quality factor 110. Or alternatively, if the base encoding is performed at a lower spatial resolution, it may require a smaller number of bits to encode each frame and so encoding may be performed at a higher CRF value that that provided by the encoding quality factor 110. By providing the base factor calculator 115, a mapping between the encoding quality factor 110 and the base quality factor 120 may be flexibly configured based on experimentation to lower overall bit rates for a given desired visual quality (which in turns facilitates transmission).

In preferred examples, the encoding quality factor 110 and the base quality factor 120 are constant values for the whole video encoding. In other cases, they may be constant for at least particular groups of pictures. If the encoding quality factor 110 and the base quality factor 120 are constant values, then the base factor calculator 115 may only need to be run once at the start of encoding.

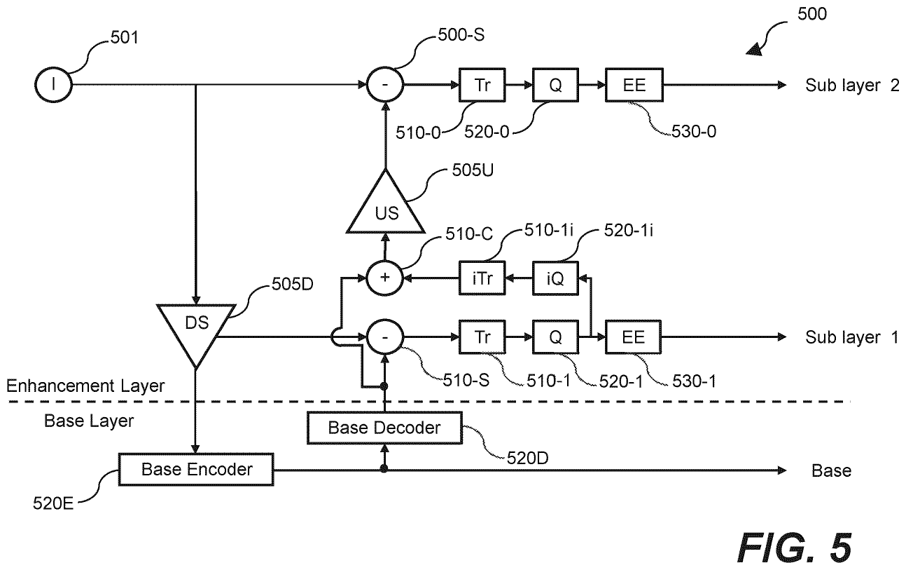

Returning to FIG. 1, in the present example, the enhancement CRF calculator 110 passes the base quality factor 120 to the base encoder 125 to obtain base encoding parameters 130 for each frame of video encoded by the base encoder 125. The base encoding parameters 130 may be output as part of the encoding process, i.e. when a frame of video data is encoded by the base encoder 125 as parameterised with the passed base quality factor 120. The base encoding is performed at a level of quality that is lower than a level of quality associated with the enhancement encoding. For example, as described later with respect to FIG. 5, the base encoding may be an encoding of a downsampled frame of video data. In other cases, levels of quality may relate to one or more of spatial resolution levels, temporal resolution levels, and quantisation levels. Different colour planes for the downsampled frame may be encoded independently. The base encoding parameters 130 may comprise, amongst others, one or more of: a frame type, a frame size, quantisation metrics or parameters for the frame (such as frame or region QP values), a frame bit rate, and bit per pixel metrics. The base encoding parameters 130 may depend on output data that is available from a particular base encoder and may vary depending on the currently used base encoder.

Within the enhancement CRF calculator 100, the base encoding parameters 130 are received by an enhancement factor calculator 135, along with the base quality factor 120 and the encoding quality factor 110. The enhancement factor calculator 135 is configured to map the encoding quality factor 110, the base quality factor 120, and base encoding parameters 130 to enhancement encoding parameters 140 for the enhancement encoding. The mapping may comprise a first mapping to an enhancement quality factor and a second mapping of the enhancement quality factor to enhancement encoding parameters 140. The enhancement encoding parameters 140 may comprise quantisation parameters for the enhancement encoding and/or bit rate parameters indicating an actual or estimate bit rate for the enhancement encoding. The enhancement encoding may be an encoding of an additive layer that may be combined with the base encoding to increase the quality of the base encoding (although the enhancement layer may comprise both positive and negative residual values). For example, a combination of a decoding of the base encoding and a decoding of the enhancement encoding provide a decoding at a level of quality that is higher than the level of quality provided be a decoding of the base encoding alone. This may be paraphrased as saying that the combination of the base encoding and the enhancement encoding provide an encoding at a second level of quality that is higher than a first level of quality that is provided by the base encoding.

The mapping performed by the enhancement factor calculator 135 may be a many-to-one mapping that maps a plurality of different base encoding parameters to a single scalar enhancement quality factor. The mapping may be a non-linear mapping (i.e., include parameterised power functions). In one case, the mapping may comprise a non-linear many-to-one mapping to a set of coefficients or parameters for a function that outputs an enhancement quality factor. The enhancement quality factor may be an integer or float value. In certain cases, the enhancement quality factor may comprise an integer value with a range similar to the original encoding quality factor 110. The enhancement quality factor may then be mapped to quantisation parameters using a further non-linear function. The enhancement factor calculator 135 may be thought of as a modulator for the initial encoding quality factor 110 based on one or more of the base quality factor 120 and the base encoding parameters 130 to output the enhancement quality factor. The enhancement quality factor may comprise a quantisation factor that is used to control the quantisation of a current frame of video during the encoding of an enhancement layer. The enhancement layer may comprise one or more residual data layers as described in more detail below. The enhancement encoding parameters 140 may vary per frame of encoded video. As such, the encoding quality factor 110 may be a CRF for the combination of the base and enhancement encoding, the base quality factor 120 may be a CRF for the base encoding (i.e., an encoding of a base layer where the base encoding is performed in a CRF mode), and the enhancement encoding parameters 140 may be based on an enhancement quality factor that is, in turn, a form of CRF for the enhancement encoding (i.e., an encoding of an enhancement layer comprising one or more sublayers that is separate from the base layer). The encoding quality factor 110 and the base quality factor 120 may be constant for the encoding of the input video, whereas the enhancement quality factor and the enhancement encoding parameters 140 may vary on a frame-by-frame basis. The enhancement encoding parameters 140 may comprise a QP or a step-width for the enhancement encoding.

Hence, via the enhancement CRF calculator 100 of FIG. 1, a single CRF may be defined for the multi-layer video encoding and then converted into different specific factors for the base and enhancement encodings, providing simple control of different encoding mechanisms that mimics existing single-layer approaches. As the enhancement encoding parameters 140 are dependent on the base encoding parameters 130 they may adapt to changes in the base encoding and reuse computations that are performed as part of the base encoding (e.g., avoiding or reducing a need to rescan the frame of input video to configure the enhancement encoding). By providing a mapping from a single encoding quality factor 110 for the video to a base quality factor 120, different base encoding approaches may be modularly implemented, and the enhancement may be efficiently applied to existing hardware and/or software codecs. By configuring the multiple mapping, particular combinations of settings may be experimental derived that reduce an overall bit rate of particular video signals for a given desired visual quality.

In certain examples described herein, the enhancement factor calculator 135 is adapted to provide one or more of “charging” and “accurate” modes of operation. In one case, an initial frame-based enhancement quality factor that is computed by the enhancement factor calculator 135 is obtained (e.g., within the enhancement factor calculator 135) and is selectively modulated based on characteristics of the input video to output a modulated encoding quality factor. The modulated encoding quality factor may be output as part of the enhancement encoding parameters 140 or may be used to compute the enhancement encoding parameters 140 (e.g., may be used to compute step widths for subsequent quantisation). In one case, the modulated encoding quality factor is used to determine quantisation parameters for encoding the current frame of data, e.g. in the form of layer step widths for different layers of the enhancement encoding.

In certain examples described herein, the enhancement encoding parameters 140 may be used to encode the current frame of data for the enhancement encoding, where the current frame of data comprises residual data computed as a difference between an original frame of the input video and a reconstruction of the original frame. In this case, the enhancement encoding parameters 140 may be complemented by an encoding bit rate metric for the encoding of the current frame of data. The encoding bit rate metric may be a computed bit per pixel (bpp) value for the encoded data. The encoding bit rate metric may be compared to a threshold to detect a change in video content complexity. Based on a result of the comparison, the encoding quality factor may be selectively recomputed, e.g. by the enhancement factor calculator 135. For example, the re-computation may comprise adjusting and/or scaling the enhancement quality factor and then re-encoding the current frame of data using the recomputed enhancement quality factor.

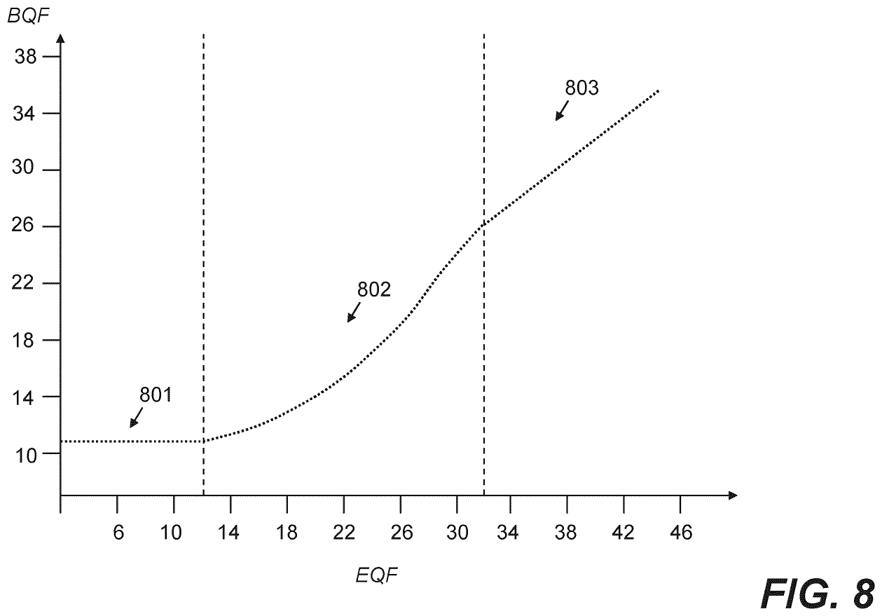

One example of a mapping that may be implemented by the base factor calculator 115 is shown by the chart of FIG. 8. In FIG. 8, an input value of the encoding quality factor 110 is shown on the x-axis and an output value of the base quality factor is shown on the y-axis. In this example, a non-linear mapping is provided with differentiated mappings for different input values of the encoding quality factor 110.

In general, the mapping functions described herein may be based on experimentation. For example, visual quality of an output decoding may be measured using one or more visual quality metrics such as Video Multimethod Assessment Fusion (VMAF) metrics developed by Tsung-Jung Liu et al. and described in a number of papers including “Visual quality assessment: recent developments, coding applications and future trends”, APSIPA Transactions on Signal and Information Processing (2013). The VMAF metrics compare an original and a decoded video and provide measures that reflect human visual perception. In tests, it was found that different visual quality metrics tended to follow common patterns of variation such that one approach (e.g., VMAF) may be taken as representative of a variety of different metrics. The problem may be considered a multi-variable optimisation problem, with the encoding quality factor 110, the base quality factor 120 and the enhancement encoding parameters 140 being variables to vary to optimise a visual quality metric such as VMAF. FIG. 8 shows an example of two dimensions of the resultant relationships for one specific base encoder.

In the mapping shown in FIG. 8, the output base quality factor 120 is dependent on an input value for the encoding quality factor 110. Three ranges are defined: a first range applied when the input value for the encoding quality factor 110 is less than 12, a second range applied when the input value for the encoding quality factor 110 is greater than or equal to 12 and less than 32, and a third range applied when the input value for the encoding quality factor 110 is greater than or equal to 32. The range values were selected empirically based on the quality of the output decoding and may vary for different implementations. In the first range, the output base quality factor 120 is clamped at a constant value (in the present case—11). In the second range, the output base quality factor 120 is a non-linear function of the encoding quality factor 110 (in the present case, a quadratic—BQF=a*EQF\hat{ }2+b*EQF+c, where a, b, and c are fitted using a curve fitting algorithm and EQF is the encoding quality factor 110). In the third range, the output base quality factor 120 is a linear function of the encoding quality factor 110 (in the present case, in the form BQF=m*EQF+c, where the coefficients m and c are determined empirically to best continue the fitted curve in the second range).

FIG. 8 shows an example mapping for one particular base codec (AV1). Different base codecs may have different ranges and functions, as well as different parameters.

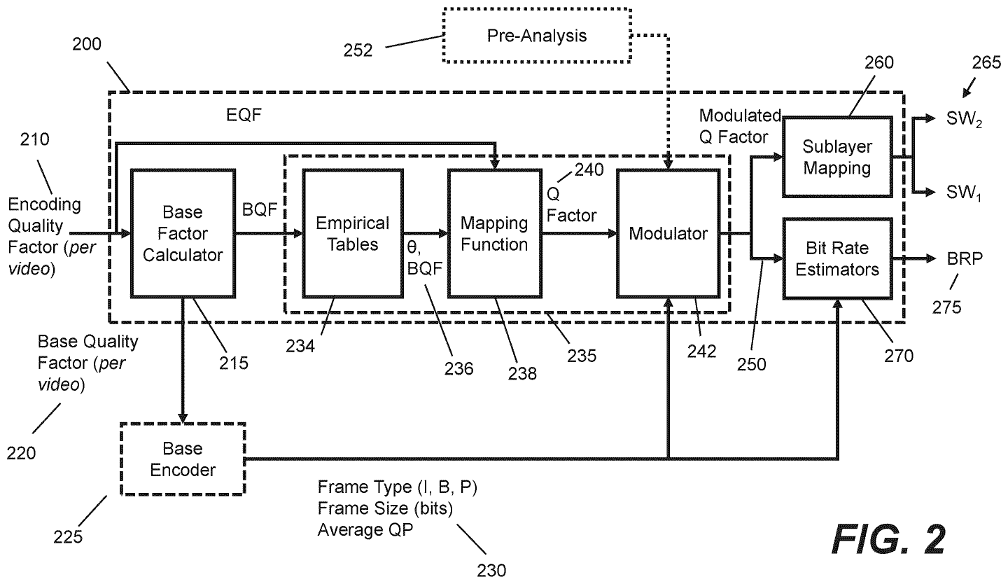

FIG. 2 shows a variation of the example of FIG. 1. In the variation of FIG. 2, components with similar reference numerals provide similar functionality to the example of FIG. 1, with additional variations as discussed below.

In FIG. 2, an enhancement CRF calculator 200 is shown that receives an encoding quality factor 210 as described with reference to FIG. 1. A base factor calculator 215 further maps the encoding quality factor 210 to a base quality factor 220 as described with reference to FIG. 1. An approach similar to that shown in FIG. 8 may be used. In FIG. 2, a base encoder 225 that implements the base encoding and receives the base quality factor 220 operates in a similar manner to the base encoder 125 of FIG. 1. In FIG. 2, the base encoding parameters 230 that are output by the base encoder per frame comprise a frame type, a frame size, and an average quantisation parameter—QP—for the frame. The frame type may indicate the frame is one of: an Intra—I—frame, a Predicted—P—frame, and a Bidirectional—B—frame, where these frame types are commonly found in many video coding standards. These three base encoding parameters 230 are received by an enhancement factor calculator 235.

The enhancement factor calculator 235 in FIG. 2 comprises a set of empirical lookup tables 234, a mapping function 238, and a modulator 242. The set of empirical lookup tables 234 are configured to use the base quality factor 220 to retrieve a set of parameters and/or coefficients 236—θ—for the mapping function 238. The mapping function 238 is configured to output a quantisation—Q—factor 240 using the set of parameters and/or coefficients 236. The Q factor 240 may be similar to the enhancement quality factor described above. The mapping function 238 is a function of the base quality factor 120 and the initial encoding quality factor 210. The base quality factor 120 may be passed through by the empirical tables or alternatively may be received from the base factor calculator 215. The mapping function 238 may comprise a non-linear function where the parameters from the empirical tables 234 set a multiplication coefficient and an exponential for the function. The Q factor 240 is similar to the enhancement quality factor 140 described with reference to FIG. 1. In the present example, there is a single Q factor 240 for multiple sublayers, but in other examples there may be separate Q factors for each sublayer. In one case, the single Q factor 240 may comprise a Q factor for one of the layers (e.g., a highest resolution sublayer) and a later mapping may derive a Q factor for another sublayer.

In the example of FIG. 2, the Q factor 240 is received by the modulator 242. The modulator 242 also receives the base encoding parameters 230 and is configured to modulate the initial Q factor 240 based on the base encoding parameters 230. The modulator 242 may further receive pre-analysis parameters, compensation factors and the like to modulate the initial Q factor 240. The output of the modulator 242 is a modulated Q factor 250. Modulation may be based on one or more of, amongst others: specific sublayer settings, a pre-analysis of the input video signal, any supplied or computed compensation factors, and resolution levels that form the levels of quality (e.g., a second level of quality that provides 4K—Ultra High Definition—UHD—output may have different adjustments than a second level of quality that provides High Definition—HD output).

In this example, the enhancement encoding comprises a plurality of sublayers. The plurality of sublayers may comprise the first and second sublayers that are found in the LCEVC encoding standard. A first sublayer may encode enhancement data at a first level of quality and a second sublayer may encode enhancement data at a second, higher, level of quality. These levels of quality may comprise spatial resolutions and/or different quantisation levels. In FIG. 2, the enhancement CRF calculator 200 also comprises a sublayer mapping 260 that receives the modulated Q factor 250. The sublayer mapping 260 maps the modulated Q factor 250 to quantisation parameters 265 for each of the plurality of sublayers. In the example of FIG. 2, these quantisation parameters 265 comprise quantisation step widths (SW) for each of the plurality of sublayers. Two quantisation step widths for two respective sublayers are shown in FIG. 2. The sublayer mapping 260 may be provided by a function and/or lookup table that provides a one-to-many mapping.

The sublayer mapping 260 allows different configurations to be programmed for rate control. For example, in certain cases, a base encoding may be more heavily quantised, but a lower sublevel may be less heavily quantised, thus allowing the lower (e.g., first) sublayer to at least partially correct the heavier quantisation. Or the first lower sublevel may be heavily quantised as well but a higher (e.g., second) sublevel is less heavily quantised, such that a higher resolution sublayer carries more of the correction. In another case, a base encoding may be less heavily quantised allowing a lower sublevel to be more heavily quantised and a higher sublevel to be less heavily quantised and thus “carry” more of the signal correction at a higher level of quality (e.g., at a higher resolution).

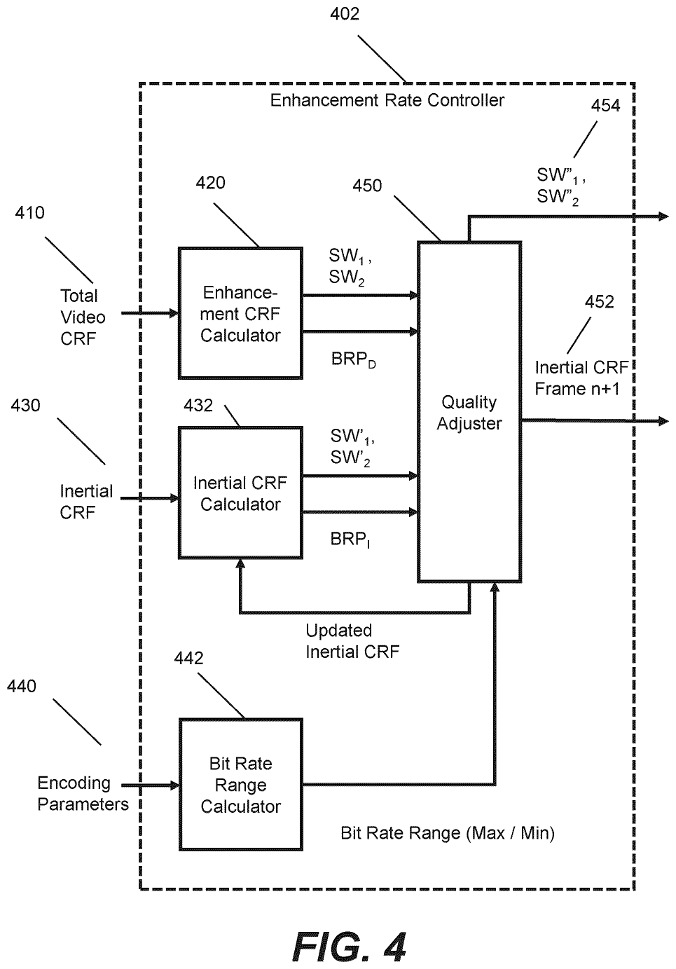

The enhancement CRF calculator 200 of FIG. 2 also comprises a set of bit rate estimators 270. These estimators 270 are configured to determine bit rate parameters (BRP) 275 for an enhancement encoding performed using the modulated Q factor 250. The bit rate estimators 270 may comprise a set of empirical functions that map the base encoding parameters 230 and the modulated Q factor 250 to a set of bit per pixel (bpp) values. The bit rate parameters 275 may be used to enact a capped CRF mode as described below with reference to FIG. 4 or to optimise an encoding where a supplied encoding quality factor 210 cannot be met due to technical constraints. The bit rate estimators 270 may not be provided if enhancement encoding proceeds without adjustment or optimisation based on the quantisation parameters 265.

The mapping function 238, in one case, may first compute a modified base quality factor from the received base quality factor 220. This may comprise applying corrections or modulation for one or more of the following: resolution of the base and/or enhancement encoding, sharpness filtering parameters, and frame rate. The mapping function 238 may then compute the Q factor 240 based on the modified base quality factor. In one case, the mapping function 238 may apply different computations for different ranges for the input encoding quality factor 210. For example, at or above a threshold computed based on the modified base quality factor, the Q factor 240 may be set as a constant. Below said threshold, the Q factor 240 may be computed as a non-linear function of the modified base quality factor and the encoding quality factor 210. In this case, coefficients including a multiplier and a power may be retrieved from a look-up table for a specified base encoder based on the modified base quality factor value. For example, below the threshold (if applied), the Q factor 240 may be computed as a linear function of the modified base quality factor and the encoding quality factor 210 as multiplied by the multiplier, with the result of the linear function being then raised to the power. The linear function may also comprise a framerate adjustment term. In certain cases, constraints or caps on the modified base quality factor and/or the Q factor 240 may be applied (e.g., applying minimum or maximum clamping).

In one example, the sublayer mapping 260 may compute the step width using a function based on the form: SW=a+(1−a)*Q_factor\hat{ }(−1/2), where a is determined empirically and Q_factor is the modulated Q factor 250. Different Q factors may be computed from the modulated Q factor 250 for each sublayer. In another case, the step widths may be computed as a linear or power function with custom multipliers and constant factors. Caps and/or clamps may also be added to improve performance.

The bit rate estimators 270 may output bit rate parameters 275 for use in rate control. For example, the bit rate parameters 275 may comprise bpp values that may be used to determine whether a defined constant bit rate is met, or whether the enhancement encoding is estimated to fall within a defined range of bit rate values (see the description of FIG. 4 below for more details). The bit rate estimators 270 may operate according to the empirically determined result that bits per pixel generally follow a hyperbolic (e.g., power) relationship with quantisation parameters or factors. For example, the base encoding may be observed to follow a hyperbolic relationship with a quantisation parameter (QP) used for the base encoding, e.g., a power relationship such as c_1*QP\hat{ }c_2, where c_1 and c_2 are empirically derived coefficients and QP is the quantisation parameter for the base frame. In one case, one or more of the coefficients may vary depending on the type of frame being encoding by the base (e.g., as indicated, together with the QP, in the base encoding parameters 230). For example, the coefficient c_2 may be greater for P frames as compared to I frames, greater for B-reference frames as compared to P frames, and greatest for B frames. Hence, a bpp estimate for the base encoding may be computed.

To calculate an estimate of bit rate parameters (e.g., a bpp value) for the enhancement encoding another hyperbolic (i.e., power) relationship may be used. For example, it was found empirically that, at least for a second (e.g., highest) sublayer, an enhancement bpp estimate had an excellent correlation (an R\hat{ }2 value of greater than 0.98) with the modulated Q factor 250. For example, a bpp estimate for a second sublayer may be computed using a function based on: base_QP_factor*c_3*((Q_factor−c_4)*C_5)\hat{ }c_6, where c_3 to c_6 are empirically derived coefficients, base_QP_factor is a base-frame-type-dependent multiplier computed from the base QP and the Q_factor is the modulated Q factor 250. In certain cases, a constant representing the additional bits per pixel for temporal signalling may also be added. The coefficient c_4 and/or any additional temporal signalling constant avoid discontinuities in the estimation function, which could cause any iterative optimisation of the encoding quality factor to become trapped by extreme values. The coefficient c_5 may be derived from the base bpp estimate described above. Coefficients c_3 and c_6 may also be base frame type dependent. In certain cases, only the multiplier c_3 is updated in an optimisation loop as described with reference to FIG. 4, e.g. based on actual encoded frame sizes. The coefficient c_3 may have values ranging from around 60 to 2, with the values varying based on the base frame type. The coefficient c_6 may have frame dependent float values around 1.

The bpp estimates for each sublayer may be based on similar functions or may comprise different functions. In one case, for the first sublayer, the second sublayer bpp estimate described above was simplified by swapping the power coefficient c_6 for a fraction based on a spatial resolution scaling factor from the first to second sublayer. In other cases, the second sublayer bpp estimate may be used with different coefficient values. In yet another case, a different function may be used.

In one example, the bit rate estimators 270 may also receive a value indicative of a total bit rate (e.g., in bytes/second or bits per pixel) for a current frame following encoding with a particular set of quantisation parameters 265. The value may be received when operating in an iterative optimisation mode (e.g., similar to the inertial CRF calculator described with reference to FIG. 4), whereby a frame estimate is first generated and then this is updated based on an actual total frame encoding value. In this manner, the estimation functions may be updated based on a difference between estimated and actual bit rate values (e.g., based on total and/or separate base and enhancement estimates).

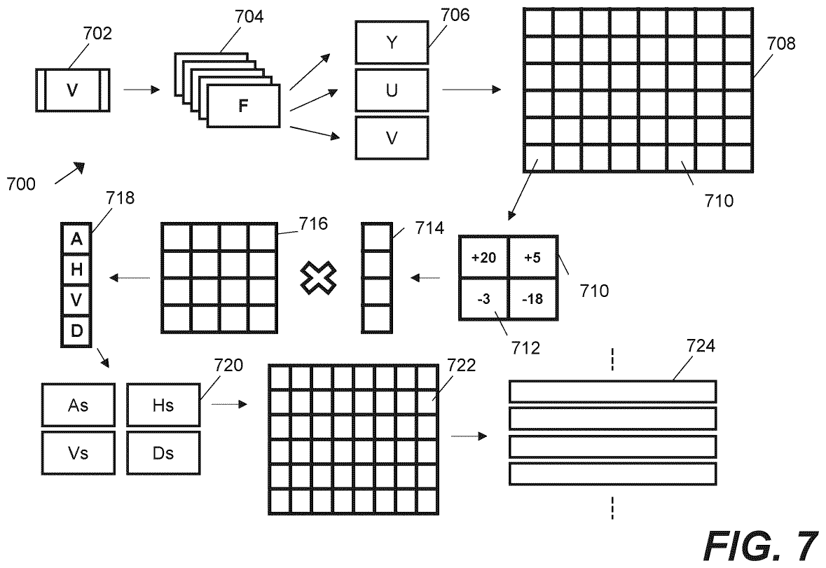

In the example of FIG. 2, one or more of the mapping function 238 and the modulator 242 may be adapted to apply a “charging” mode. In one case, the initial enhancement quality factor 210 is “charged” prior to the above-described computations (e.g., prior to generating the output Q factor 240). This “charging” may change the initial enhancement quality factor 210 to improve decoded output quality. In this case, the initial enhancement quality factor 210 is modulated based on characteristics of the input video (i.e., characteristics of input frames of the video). The modulation may be applied such that reference frames, e.g. for a temporal mode, are encoded using more bits. This then ensures the reference frames are decoded at a higher quality and thus helps lower temporal residuals that are generated as a difference between successive frames of data. Temporal residuals may be computed during encoding as a difference between blocks (i.e., coding units) of residual data for different frames. Modulation may be performed despite a temporal mode being used (and signalled) on a block-by-block and/or tile-by-tile basis, e.g. turned on and off for different 2×2 or 4×4 blocks of residuals and/or turned on and off for different groups of blocks that are denoted as “tiles”. The “charging” may thus be applied as an independent process to the application of the temporal mode. One or more of the modes may receive pre-analysis information from a pre-analysis module 252. The pre-analysis module 252 may compute various image metrics based on the video data being encoded. The pre-analysis module 252 may operate on one or more of: the original video pixel data, the residual data computed as a frame difference (e.g., residual data values 712 in FIG. 7), and the transformed residual data (i.e. “transformed coefficients” such as 718 in FIG. 7).

In the “charging” mode, the selective modulation of the encoding quality factor may be designed to lower the encoding quality factor for frames that are likely to be used as reference frames in a temporal mode. Reference frames may not be explicitly labelled as such but may comprise coding blocks and/or tiles that are subtracted from subsequent coding blocks and/or tiles for a corresponding spatial area in order to compute temporal residuals (residuals across time for residuals between an original frame of video and a reconstructed frame of video). Further details regarding temporal residuals are to be found in WO 2020/188273 A1. By lowering the encoding quality factor, one or more step widths, such as 265, for one or more enhancement layers may be lowered, thus assigning more bits to encode the coding blocks and/or tiles of the reference frames.

In one case, selectively modulating the encoding quality factor comprises determining a ratio of static image portions to non-static image portions for the current frame of data and modulating the encoding quality factor based on the ratio to lower a quantisation step width responsive to a presence of static image portions. Determining a ratio of static image portions to non-static image portions for the current frame of data may comprises computing a number of frame data metrics. In one case, intra-frame and inter-frame metrics are computed, e.g. metrics that are computed using data for a current frame (intra-frame metrics) and metrics that are computed using data for a current frame and data for a preceding or previous frame (inter-frame metrics). In one case, the selective modulation may comprise computing an intra-frame data metric for each of a set of coding units for the current frame of data and computing an inter-frame data metric for each of a set of coding units for the current frame of data. The intra-frame data metric may be calculated based on sum of absolute values in the current frame of data (e.g., a sum of absolute residual values for a coding unit—ZS). The inter-frame data metric may be calculated based on a sum-of-absolute differences (SAD) metric, e.g. pixel or residual values for a previous frame are subtracted from a current frame and the absolute values of the differences are computed than summed. The metrics may be computed across all coding units or for a sampled subset of coding units. In one case, the metrics are computed based on residual values (e.g., differences between original pixel data for a frame and reconstructed pixel data for the frame, where these differences may be computed per coding block or unit). The metrics may be computed after a transformation has been applied to the residual data (e.g., based on so-called transformed coefficients). The inter-frame and intra-frame metrics may be computed using values for the transformed coefficients, e.g. on residual values that have been transformed using a Hadamard transformation as described later with respect to FIG. 7 (e.g. on 718).

In one case, a number of statistical variables may be computed based on intra-and inter-frame conditions. For example, a count or proportion of coding units in the current frame that meet one or more sets of conditions may be determined, each count or proportion representing a different statistical variable. One or more of the following conditions may be evaluated:
Whether a coding unit carries significant information (e.g., an intra-frame metric based on a sum of absolute residual values within the coding unit); and
Whether a coding unit significantly differs from the same coding unit but in a previous frame (e.g., an inter-frame metric based on a SAD value for the coding unit).

In one case, the following statistical variables may be computed:
a both_zero metric indicating that both an intra-frame and inter-frame metric (e.g., as set out above) are zero (e.g., SAD=0 && ZS=0)—this means the coding unit does not carry significant information and has no significant difference with the same coding unit in the previous frame. This may represent static image portions that also feature little within-unit variation.
a inter_zero metric indicating that an inter-frame metric has a zero value but an intra-frame metric has a non-zero value (e.g., only SAD=0)—this means the coding unit does carry significant information but has no significant difference with the same coding unit in the previous frame. This may represent static image portions.
an intra_zero metric indicating that an intra-frame metric has a zero value but an inter-frame metric has a non-zero value (e.g., only ZS=0)—this means the coding unit does not carry significant information but has a significant difference with the same coding unit in the previous frame. This may represent non-static image portions that feature little within-unit variation.
an intra_lower metric that indicates that an intra-frame metric is less than an inter-frame metric (e.g., ZS<SAD).
an inter_lower metric that indicates an inter-frame metric is less than an inter-frame metric (e.g., ZS>SAD).
   The statistical variables above may be computed as a count of coding units that meet the various indicated conditions. For example, the both_zero metric may comprise a count of coding units within the frame that meet the condition-(SAD=0 && ZS=0). In certain cases the both_zero, inter_zero, and inter_lower metrics may be used to signal an inter transformation for a temporal signal and the intra_zero and intra_lower metrics may be used to signal an intra transformation for the temporal signal. In this case, the computation method may comprise comparing the intra-frame and inter-frame data metrics to respective thresholds to classify each of the set of coding units based on intra-frame and inter-frame variation. For example, in the above examples, there is a zero threshold and the indicated conditions are used to classify then count coding units within a current frame.

In one case, a plurality of the metrics described above may be used to compute ratios that are used to modulate the encoding quality factor. For example, an initial encoding quality factor may be modulated by subtracting one or more factors that are computed based on the plurality of metrics. The charging may be applied such that the encoding quality factor is only modulated downwards (e.g., to increase a quality of encoding). This may be achieved by using a minimum of the initial encoding quality factor and the modulated encoding quality factor. In one case, the initial encoding quality factor is reduced using a baseline factor and one or more boost factors. The baseline factor may be computed by first determining a baseline peak factor. The baseline peak factor may comprise a function of the ratio—inter_zero/(1−both_zero), i.e. the ratio of coding units that carry information but have no significance difference with the previous frame and the number of coding units that have some significant inter and/or intra differences. This may be seen as a ratio of static portions over non-static portions. The statistical variables may be represented as percentages or decimal values (e.g., between 0 and 1) representing a count of coding units meeting the conditions over the number of counted coding units (e.g., all coding units or all sampled coding units). The baseline factor may be adjusted based on the initial encoding quality factor value and/or the base quality factor 220. The one or more boost factors may comprise functions of the aforementioned ratio and/or the ratio—(inter_zero+inter_lower)/(1−both_zero). Both ratios seek to capture within a metric an indication that the current frame contains coding units that are informative (e.g., comprise significant information) but do not significantly differ from a previous frame.

In the examples above, a baseline of modulation is determined based on a ratio of static image portions (as represented by inter_zero) and non-static image portions (as represented by (1−both_zero). Subsequent computations may be seen as a smoothing of the baseline based the ratio of static image portions to non-static image portions for the current frame of data and using the baseline to modulate the initial encoding quality factor. The “charging” may be implemented as a fractional multiplier for an initially received encoding quality factor (e.g., a normalised float multiplier in the range of 0 to 1).

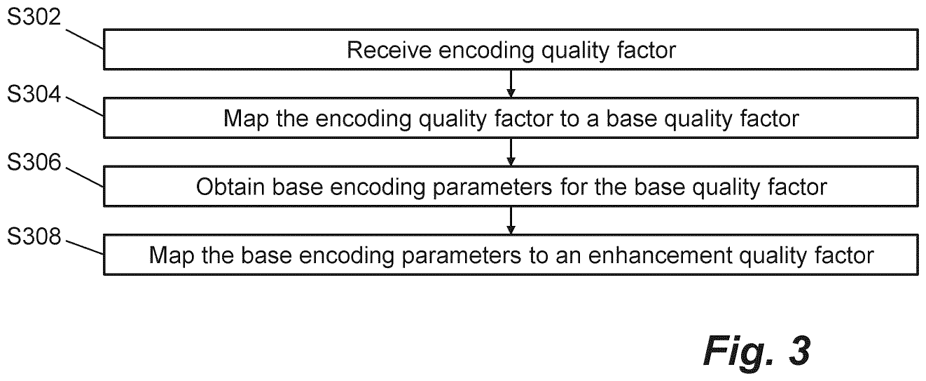

FIG. 3 shows an example method of computing encoding parameters for an encoding of an input video. In this case, the encoding parameters are rate control parameters that control the number of bits that are used to encode each frame of video. The method comprises a number of steps. At step S302, the method comprises receiving an encoding quality factor indicating a desired visual quality for an encoding of the input video. This may comprise encoding quality factor 110 or 210 in FIGS. 1 and 2. The desired visual quality is a perceived visual quality of a decoding of the encoding of the input video. Typically, the encoding is lossy so there will be some quality differences between the input video and the decoding; the encoding is often configured to compress the input video to make it easier to store and transmit the video content. At step S304, the encoding quality factor is mapped to a base quality factor indicating a desired visual quality for a base encoding of the input video. This may comprise the mapping performed by the base factor calculator 115 or 225 in FIGS. 1 and 2. The base encoding provides an encoding at a first level of quality. For example, the base encoding may comprise an encoding at a spatial resolution lower than the input video and/or with heavy quantisation to reduce a bit rate. At step S306, the method comprises obtaining base encoding parameters for the base quality factor. For example, these may be base encoding parameters that represent a base encoding of a current frame at the base quality factor. The base encoding parameters may be obtained from a base encoder, such as base encoding parameters 130 or 230 in FIGS. 1 and 2. At step S308, the base encoding parameters, the base quality factor, and the encoding quality factor are mapped to enhancement encoding parameters for an enhancement encoding. For example, this may be performed by enhancement factor calculator 135 or 235 in FIGS. 1 and 2. In the present example, a combination of the base encoding and the enhancement encoding provide an encoding at a second level of quality that is higher than the first level of quality. For example, the enhancement encoding may encode residual data that is decoded and combined with a decoding of the base encoding to generate an output at the second level of quality. The enhancement encoding may be an LCEVC encoding as described in more detail with reference to FIGS. 5 to 7.

In certain variations, the encoding quality factor is a constant rate factor for the combination of the base and enhancement encoding and the base quality factor is a constant rate factor for the base encoding, the base encoding being performed in a constant rate factor mode. The encoding quality factor and the base quality factor are preferably constant for the encoding of the input video, wherein steps S306 and S308 are performed for each frame of the input video.

In certain cases, the enhancement encoding comprises a plurality of sublayers having different levels of quality, and the method further comprises mapping an enhancement quality factor determined from the base encoding parameters, the base quality factor, and the encoding quality factor to quantisation parameters for each of the plurality of sublayers. For example, this is shown in the form of quantisation parameters 265 in FIG. 2. This may be performed by the enhancement factor calculator 235 and the sublayer mapping 260 in FIG. 2. The quantisation parameters may comprise quantisation step widths for each of the plurality of sublayers. The method may also optionally comprise adjusting the quantisation step widths for each of the plurality of sublayers based on characteristics of the input video.

In certain examples, a specific enhancement encoding scheme may be used. In one such case, the input video may be received at a first spatial resolution (e.g., HD or UHD) and the method may comprise a number of steps on a frame-by-frame basis. To start, a current frame of the input video may be downsampled to create a downsampled frame at a second spatial resolution that is lower than the first spatial resolution. For example, the second spatial resolution may be HD or Standard Definition—SD—content for respective original UHD or HD content. As part of the method, the base encoding of the downsampled frame may be instructed using the base encoder to create a base encoded stream. For example, an enhancement encoder may call an operating system encoding method and/or execute a defined executable file representing a registered and selected base encoder. This instructing may comprise passing the base quality factor to the base encoder, e.g. as part of a command line parameter or base configuration file. Following this, a reconstruction of the current frame at the second spatial resolution is reconstructed from a decoding of the base encoded stream (i.e., a decoding of the current frame in the base encoded stream, which may depend on other encoded frames if motion compensation is applied). Then an enhancement encoder computes residual data for a first sublayer of the plurality of sublayers as a difference between the reconstruction of the current frame at the second spatial resolution and the downsampled current frame. For example, this may comprise the process of constructing an LCEVC first sublayer. Then, the residual data for the first sublayer is encoded using a quantisation step width as determined by the above methods to generate encoded residual data for the first sublayer. A decoding of the encoded residual data for the first sublayer is then combined with the reconstruction of the current frame to generate a corrected reconstruction of the current frame. The corrected reconstruction of the current frame is upsampled to the first spatial resolution and residual data for a second sublayer of the plurality of sublayers is computed as a difference between the upsampled corrected reconstruction of the current frame and the current frame. Lastly, the residual data for the second sublayer using the quantisation step width for the second sublayer as described above to generate encoded residual data for the second sublayer. The enhancement encoder thus outputs an encoded enhancement stream. The encoded enhancement stream may be multiplexed with the encoded base stream that is output by the base encoder or they may be used as separate streams (e.g., stored and/or transmitted as appropriately configured bit streams). More detail of the process of generating this particular enhancement encoding is described with reference to FIGS. 5 to 7.

In certain variations, the method is applied on a frame-by-frame basis and the base encoding parameters comprise one or more of: a frame type; a frame size in bits; and a quantisation metric for the frame. In a preferred case, all three base encoding parameters are provided as shown in the example of FIG. 2. The frame type may indicate one of: an Intra—I—frame, a Predicted—P—frame, and a Bidirectional—B—frame. The quantisation metric may comprise an average quantisation parameter—QP—for the frame. The quantisation metric may alternatively comprise QPs for different regions of interest.

In certain cases, mapping the encoding quality factor and/or mapping the base encoding parameters comprises using one or more look-up tables. For example, these look-up tables may store function parameters or mapped output values. Interpolation and rounding may be used where desired depending on implementation.

In one particular variation, mapping the encoding quality factor and/or mapping the base encoding parameters comprises using one or more trained neural network architectures. For example, training samples comprising tuples of base encoding parameters and an enhancement quantisation factor (e.g., a normalised scalar or integer output) may be generated and these may be used to train a feed-forward neural network with at least one hidden layer using off-the-shelf backpropagation methods (e.g., as applied by the PyTorch or Tensorflow software libraries). The feed-forward neural network may then be used with the trained parameters in an inference mode to predict the enhancement quantisation factor from the input base encoding parameters. A similar method may be applied with training data in the form of encoding quality factors and base quality factors.

In one case, mapping the encoding quality factor to the base quality factor comprises: determining a base encoding type, the base encoding type being selected from a plurality of different available base encoding types based on the base encoder used for the base encoding; and configuring a mapping for the determined base encoding type. For example, the base factor calculator 115 or 215 in FIGS. 1 and 2 may perform a different calculation based on a detected base encoder 125 or 225.

In certain cases, mapping the encoding quality factor, the base quality factor and the base encoding parameters to enhancement encoding parameters comprises mapping a plurality of base encoding parameters, the base quality factor, and the encoding quality factor to quantisation step-widths and estimated bit rate parameters for the enhancement encoding. For example, this may be performed using a configuration similar to that shown in FIG. 2. The method may comprise retrieving a set of coefficients based on the value of the base quality factor and computing an enhancement quality factor as a non-linear function of the base quality factor and the encoding quality factor, the non-linear function being configured based on the set of coefficients.

In certain cases, the method may comprise, for a given frame, determining a range of available bit per pixel values for the enhancement encoding, obtaining a set of encoding settings based on an encoding of a previous frame, using the range of available bit per pixel values and the set of encoding settings to adjust the encoding quality factor; and repeating the method with the adjusted encoding quality factor prior to encoding. An example of this process is described with reference to FIG. 4 below. Determining the range of available bit per pixel values for the enhancement encoding may comprise determining a first range of available bit per pixel values based on a set of encoding parameters, determining a second range of available bit per pixel values based on a buffer arranged to store encoded bits from the base and enhancement encodings, and outputting minimum and maximum bit per pixel values as constrained by the first and second ranges.

FIG. 4 shows an example of an enhancement rate controller 402 that may use a suitably configured version of the enhancement CRF calculator 100 or 200 of FIGS. 1 and 2. The enhancement rate controller 402 is configured to output quantisation parameters in the form of adjusted step widths SW′₁ and SW′₂ for two sublayers of an enhancement encoding scheme to be used for encoding a given frame (or coding unit) of a video signal. The enhancement rate controller 402 may be seen to implement a form of capped CRF encoding, where the cap may be set based on one or more of explicitly provided parameters and/or feedback from the encoding process. The enhancement rate controller 402 implements a form of “inertial control” in which encoding settings from an enhancement encoding of one or more preceding frames are used to modify the output of the enhancement CRF calculator 100 or 200 of FIGS. 1 and 2. The enhancement rate controller 402 may also adjust quantisation parameters to take into account bit rate ranges, such as bits per pixel limits set by hardware, software, or user configurations. In one case, bit rate ranges may be set based on a “leaky bucket” approach that is used to multiplex the base and enhancement encodings. In this case, a buffer is used for output bits from the base and enhancement encodings to maintain a desired bit rate or bit rate cap for the multi-layer stream across both encodings.

In the example of FIG. 4, the enhancement rate controller 402 adjusts the bit rate for each enhancement sublayer by determining the quantisation parameters SW′₁ and SW′₂ based on multiple input parameters. In particular, the enhancement rate controller 402 is configured to determine quantisation parameters SW″₁ and SW″₂ for each frame in a set of multiple frames of video to be encoded. Feedback from the encoding of a previous frame may be used to set the quantisation parameters SW′₁ and SW″₂ for a current frame. In FIG. 4, the enhancement rate controller 402 receives a total video CRF 410

for the multi-layer encoder (e.g., for the “total” video comprising base and enhancement layers). This may comprise the encoding quality factor 110 or 210 as shown in FIGS. 1 and 2. This may be received as an encoding input parameter. The total video CRF 410 is input to an enhancement CRF calculator 420. The enhancement CRF calculator 420 may comprise an implementation of one or more of the enhancement CRF calculators 100 and 200 of FIGS. 1 and 2. As such, the enhancement CRF calculator 420 is configured to process the total video CRF 410 and an enhancement quality factor in the form of output quantisation parameters for each sublayer of an enhancement stream. In this example, the enhancement CRF calculator 420 may further be adapted to also output bit rate parameters BRPD. For example, the bit rate parameters BRPD may comprise bit per pixel (bpp) values for an enhancement encoding that uses the calculated quantisation parameters. The bit rate parameters BRPD may be measured based on an actual encoding of the enhancement sublayers and/or estimated by a predictive system based on the quantisation parameters. The bit rate parameters BRPD may be generated by bit rate estimators similar to those described in FIG. 2.

The enhancement rate controller 402 also uses an implementation of the enhancement CRF calculator 100 or 200 of FIGS. 1 and 2 to implement a further CRF calculator for an inertial CRF 430 in the form of inertial CRF calculator 432. In this case, an encoding quality factor (e.g., in the form of a CRF value) is determined based on one or more preceding frames. This “inertial” CRF 430 may differ from the received total video CRF 410. For example, due to bit rate or other system limitations, a desired total video CRF 410 may not be achievable and so an alternative lower CRF may need to be used to encode one or more preceding frames. Or alternatively, a scene represented in one or more frames being encoded may be less complex than average, allowing a higher CRF to be achieved. In FIG. 4, the inertial CRF calculator 432 operates in a similar manner to the enhancement CRF calculator 420 but using the inertial CRF 430 as input. This may result in different quantisation parameter outputs, e.g. in the form of different step width parameters SW′₁ and SW′₂. The enhancement CRF calculator 420 and the inertial CRF calculator 432 may comprise different instantiations of a common program code class and/or duplicates of a common hardware chip.

As with the enhancement CRF calculator 420, the inertial CRF calculator 432 may also output an inertial bit rate parameters BRPI. Again, the bit rate parameters BRPI may comprise bit per pixel (bpp) values for an enhancement encoding that uses the inertial quantisation parameters. The bit rate parameters BRPI may be measured based on an actual encoding of the enhancement sublayers and/or estimated by a predictive system based on the quantisation parameters.

Lastly, the enhancement rate controller 402 also receives an encoding parameter input 440. This may comprise additional user-set constraints for the encoding and/or constraints set by the encoding process. The encoding parameter 440 may comprise parameters from the base operating parameters 130 or 230. For example, the encoding parameter input 440 may comprise one or more operating parameters such as one or more of: a frame type, a bit rate or frame size of the base layer, a minimum desired bit rate, a target bit rate, and parameters based on a previous frame encoding. The operating parameters may be derived from the “leaky bucket” output buffer. The bit rates may be defined as bits per pixel values.

In FIG. 4, the encoding parameter input 440 is provided to a bit rate range calculator 442. The bit rate range calculator 442 receives the encoding parameter input 440 and determines a bit rate range, such as a maximum and minimum bit rate (e.g., in the form of bit per pixel values) for the enhancement sublayers. The bit rate range calculator 442 may comprise a repeated process of determining maximum and minimum bit rates according to different sets of constraints to determine an overall maximum and minimum bit rate.

The outputs of the enhancement CRF calculator 420, the inertial CRF calculator 432 and the bit rate range calculator 442 are input to a quality adjuster 450. This may apply functionality similar to certain functionality provided by the adjustment stage 260 in FIG. 2. The quality adjuster 450 is configured to process the input and determine a final set of quantisation parameters SW′₁ and SW′₂ for a current frame to be encoded. In one case, the quality adjuster 450 determines whether one or more of the received desired bit rate parameters BRD and inertial bit rate parameters BR, from the enhancement CRF calculator 420 and the inertial CRF calculator 432 are within the bit rate range output by the bit rate range calculator 442. If one of the input bit rate parameters are within the bit range, a corresponding one of the quantisation parameters may be selected and used as the adjusted quantisation parameters SW″₁ and SW″₂ that are output by the enhancement rate controller 402. If none of the input bit rate parameters are within the bit rate range, then the quality adjuster 450 may be configured to adjust the quantisation parameters and output an updated inertial CRF that is within the bit rate range. The quality adjuster 450 is configured to use the output of the enhancement CRF calculator 420 as a reference to adjust the inertial CRF 430 in a direction that is associated with an increase or reduction of the bit rate so as to fall within the bit rate range. The inertial CRF calculator 432 may then be iteratively activated to output revised quantisation parameters SW′₁ and SW′₂ and revised inertial bit rate parameters BRPI based on the updated inertial CRF value received from the quality adjuster 450. This feedback loop may be iterated until a revised inertial bit rate BRP, fall within the bit rate range from the bit rate range calculator 442.

When a bit rate output by one or more of the enhancement CRF calculator 420 and the inertial CRF calculator 432 is found to fall within the bit rate range, and a final set of quantisation parameters SW″₁ and SW′₂ are output, the quality adjuster 450 is also configured to output an inertial CRF 452 to be used for a next frame (e.g. frame n+1). The inertial CRF 452 may be used as the inertial CRF 430 for the next frame (whereas the total video CRF 410 may be constant across the whole video).

As described above, the enhancement rate controller 402 takes multiple input parameters to output a final set of quantisation parameters SW″₁ and SW″₂ for a set of enhancement sublayers and an inertial CRF value for a next frame 452.

For a first frame of video data, or where an inertial CRF 430 is not available, the inertial CRF 430 may be set as the total video CRF 410. As described previously, this may be an initial user-set, or otherwise predetermined, value. As also described previously, the total video CRF 410, the inertial CRF 430 or the inertial CRF 452 may have a common format and may be any suitable objective quality metric. In one case, they may be an 8-bit integer value within a predefined range of quality values representing a perceptive quality of an output decoded video.

In the example of FIG. 4, the previously described methods of computing quantisation parameters from an encoding quality factor may be used within enhancement CRF calculator 420 and the inertial CRF calculator 432 to determine a level of quantisation required for each sublevel of enhancement based on an indication of quality. In a capped CRF case, a bit rate range, e.g. in the form of maximum and minimum bpp values may also be determined, e.g. either based on a user-input value or feedback from a multiplexer that is combining the base and enhancement streams. The bit rate range may be used to constrain or adjust the determined level of quantisation. Parallel CRF calculators allow different quantisation parameters to be determined when an initial total video CRF cannot meet additional bit rate constraints, e.g. by simulating, predicting or evaluating the effect of encoding at adjusted CRF values. Within a multilayer coding scheme, the total amount of data required to encode a frame is a complex non-linear function of both base and enhancement encoding pipelines, as well as often being dependent on a complexity of a scene in the video signal. This means that quantisation parameters may change from frame to frame. By using an inertial model, a certain amount of damping or smoothing may be applied to prevent abrupt changes in quantisation and to determine alternative CRF values more efficiently and effectively if a supplied desired value cannot be met. The enhancement rate controller 402 thus is a dynamic system where the outputs of the components change per frame and for a given frame.

The encoding parameter input 440 defines a number of parameters used in the encoding process. These may include a target rate factor (or quality level) and target bit rate. The encoding parameter input 440 may also include a range, in the form of the maximum and minimum value for such parameters. The bit rate range calculator 442 may compare different bit rate range indications as provided by the encoding parameter input 440 to determine an overall bit rate range.

In certain examples, an enhancement encoder may utilise a buffer that is implemented according to a leaky bucket model to determine a level of quantisation for a frame of data (e.g., in cases where the enhancement encoder also applies a multiplexer to output a combined base and enhancement stream). As the amount of data required to encode a frame may vary depending on the complexity of the frame, the contents of the buffer need to be controlled such that the buffer does not overflow (e.g., such that more data is encoded that may be supported by an available bandwidth or bit rate). In this case, the encoding parameter input 440 may comprise measurements associated with the buffer such as a buffer capacity and a minimum bit rate to fill the buffer. Measurements associated with the buffer (i.e., leaky bucket parameters) may thus be used by the bit rate range calculator 442 to determine a bit rate range for one or more enhancement streams.

Using the enhancement rate controller 400 of FIG. 4, a frame of video may be encoded with multiple levels of quantisation, with preferably each of the base stream and the enhancement stream being encoded at different levels of quantisation. The encoding within these examples is repeated for multiple frames using a frame-by-frame process.

In certain implementations, as indicated above, for each frame, the encoding process may comprises reconstructing a frame of video at each respective level of quality for multiple enhancement substreams and subsequently comparing the reconstructions with video data derived from a frame of the input video at each of the respective quality levels. Such a comparison therefore allows for the differences between the original and reconstructed frames to be made. In one case for each frame, a set of residuals for the frame of video may be generated at each of two enhancement sublevels based on the comparison, and these residuals may be encoded using the quantisation parameters for the two enhancement streams that are output via the operation of one or more of the enhancement CRF calculators 100 or 200 or the enhancement rate controller 402. It should be noted that the enhancement rate controller 402 is only one particular example for implementing a capped CRF, and certain enhancement rate controllers may not comprise the components shown in FIG. 4 but simply use the enhancement encoding factor 140 of FIG. 1 or the quantisation parameters 265 of FIG. 2 to encode the enhancement streams or substreams. The process may be repeated across multiple frames of data, so as to encode a complete video (e.g., a video file or video stream for transmission). The frames are encoded within the multilayer stream so as to meet or attempt to meet the input indication of a desired quality level. This provides a simple way in which a non-technical user may set complex technical quantisation parameters for multiple different encoding approaches so as to obtain a desired level of quality.

In certain variations, the methods above may be adapted to implement an “accurate” mode. The “accurate” mode provides functionality similar to the quality adjuster 450 in FIG. 4, in that it allows for revised step widths to be computed in response to changes in video conditions. The “accurate” mode may be used when encoding is configured to use a single pass, and may provide an opportunity to selectively recompute the encoding quality factor and reperform an encoding of a given frame with the recomputed encoding quality factor. This can provide the capacity to react to a sudden change of content complexity.

In one case, a quality adjuster for the “accurate” mode obtains a target bit rate metric for the encoding of the current frame of data and an encoding bit rate metric for the encoding of the current frame of data. For example, the encoding bit rate metric may be provided as part of the bit rate parameters (BRP) shown in FIG. 2 (i.e., 275) and FIG. 4 (BRP_{D}). The target bit rate may be provided as part of the encoding parameters 440 shown in FIG. 4. The “accurate” mode may be toggled on and off based on one or more of a mode flag and an encoding bit rate overshoot. In this case, if the mode flag is set to “false” the “accurate” mode is not used. If the mode flag is set to “true”, then the encoding bit rate overshoot is compared to a threshold. If the encoding bit rate overshoot is at least greater than the threshold, the “accurate” mode is activated and the encoding quality factor is recomputed. The encoding bit rate overshoot may be defined as a ratio of the encoding and target bit rate metrics. The threshold may indicate a level by which the encoding bit rate metric exceeds the target bit rate metric.

The re-computation of the encoding quality factor may be performed by components that are similar to one or more of the mapping function 238 and the modulator 242. Once the encoding quality factor is recomputed it may be used to regenerate step widths for the additional encoding pass. The step widths may be computed by a sublayer mapping similar (or the same as) sublayer mapping 260 in FIG. 2 (e.g., sublayer mapping 260 may receive the recomputed encoding quality factor and output recomputed step widths 265). Recomputing the encoding quality factor may comprise one or more of adjusting and scaling the obtained encoding quality factor. In one case, a constant is subtracted from the encoding quality factor used for the initial encoding pass and the result is divided by a coefficient. The output of those computations may be set to be positive (e.g., using max(computation, 0)) and the constant may be further added to that positive result (e.g., the recomputation may comprise max(((initialEQF−constant)/coefficient), 0)+constant). The coefficient may be a function of the overshoot magnitude (e.g., based on the encoding bit rate metric minus the target bit rate metric) and the constant may be determined empirically (it may comprise a small value less than 0.1).

The re-computation of the encoding quality factor may be adjusted based on whether the current frame of data has undergone a pre-encoding prioritisation operation. The pre-encoding prioritisation operation may comprise a residual prioritisation mode that is described as a residual selection mode in WO 2020/188273 A1. In this mode, residual values may be weighted. The pre-encoding prioritisation operation may include adjusting a pre-quantisation of residual values prior to transformation and/or quantisation operations. The pre-encoding prioritisation operation may comprise enhancing certain residual values, e.g. residual values that are used as a reference for a temporal mode. When a pre-encoding prioritisation operation is being used, a coefficient (e.g., based on an overshoot magnitude) may be reduced by raising an original coefficient value to a power of less than 1. This is because when a pre-encoding prioritisation operation is being used, the bit rate of the enhancement encoding may more rapidly tend towards zero for relatively high step widths. Reducing the scaling when a pre-encoding prioritisation operation is being used may help to reduce feedback effects between the pre-encoding prioritisation operation and the re-computation.

In general, the “accurate” may help reduce or remove spikes or errors in encoding parameter estimation by running another pass of encoding with amended parameters. For example, in encoding with the constant rate factor methods described herein, it is sometimes seen that one frame has a spike in bit rate, indicating that lower step widths have been used and many bits have been allocated to that frame. However, when this occurs, due to overall bit rate limitations for the enhancement stream, subsequent frames may need to be encoded with a lower bit rate leading to subsequent lower quality decoded frames. Spikes may occur when there is an abrupt scene change or an abrupt change in lighting or frame contents. The present “accurate” mode can detect these spikes (e.g., in the form of an encoded bit rate being much larger than a target bit rate) and act to smooth their effect (e.g., by using a higher encoding quality factor with higher step widths for the current “spike” frame, which then allows lower encoding quality factors with lower step widths for subsequent frames).

The above methods may be used to encode video data. For example, an encoder may be adapted to perform the methods as described herein. In a software implementation, a computer program may be provided comprising instructions which, when the program is executed by a computer, cause the computer to carry out the methods as described herein, i.e. when executed by one or more processors of a computing device. The computer program may be stored upon a non-transitory computer-readable medium. The described methods and/or apparatus may be used to generate an enhancement bit stream that is encoded using the enhancement encoding parameters as computed by the described methods and/or apparatus. A decoder may be provided that is configured to decode this enhancement bit stream and to combine an output of said decoding with a decoding of the base encoding to generate a reconstruction of the input video.

Certain general information relating to example enhancement coding schemes will now be described. This information provides examples of specific multi-layer coding schemes.

It should be noted that examples are presented herein with reference to a signal as a sequence of samples (i.e., two-dimensional images, video frames, video fields, sound frames, etc.). For simplicity, non-limiting examples illustrated herein often refer to signals that are displayed as 2D planes of settings (e.g., 2D images in a suitable colour space), such as for instance a video signal. In a preferred case, the signal comprises a video signal. An example video signal is described in more detail with reference to FIG. 7. Although examples are described specifically in relation to video, the approaches may also be used for other forms of media such as audio or subtitle data.

The terms “picture”, “frame” or “field” are used interchangeably with the term “image”, so as to indicate a sample in time of the video signal: any concepts and methods illustrated for video signals made of frames (progressive video signals) can be easily applicable also to video signals made of fields (interlaced video signals), and vice versa.

Despite the focus of examples illustrated herein on image and video signals, people skilled in the art can easily understand that the same concepts and methods are also applicable to any other types of multidimensional signal (e.g., audio signals, volumetric signals, stereoscopic video signals, 3DoF/6DoF video signals, plenoptic signals, point clouds, etc.). Although image or video coding examples are provided, the same approaches may be applied to signals with dimensions fewer than two (e.g., audio or sensor streams) or greater than two (e.g., volumetric signals).

In the description the terms “image”, “picture” or “plane” (intended with the broadest meaning of “hyperplane”, i.e., array of elements with any number of dimensions and a given sampling grid) will be often used to identify the digital rendition of a sample of the signal along the sequence of samples, wherein each plane has a given resolution for each of its dimensions (e.g., X and Y), and comprises a set of plane elements (or “element”, or “pel”, or display element for two-dimensional images often called “pixel”, for volumetric images often called “voxel”, etc.) characterized by one or more “values” or “settings” (e.g., by ways of non-limiting examples, colour settings in a suitable colour space, settings indicating density levels, settings indicating temperature levels, settings indicating audio pitch, settings indicating amplitude, settings indicating depth, settings indicating alpha channel transparency level, etc.). Each plane element is identified by a suitable set of coordinates, indicating the integer positions of said element in the sampling grid of the image. Signal dimensions can include only spatial dimensions (e.g., in the case of an image) or also a time dimension (e.g., in the case of a signal evolving over time, such as a video signal). In one case, a frame of a video signal may be seen to comprise a two-dimensional array with three colour component channels or a three-dimensional array with two spatial dimensions (e.g., of an indicated resolution-with lengths equal to the respective height and width of the frame) and one colour component dimension (e.g., having a length of 3). In certain cases, the processing described herein is performed individually to each plane of colour component values that make up the frame. For example, planes of pixel values representing each of Y, U, and V colour components may be processed in parallel using the methods described herein.

Certain examples described herein use a scalability framework that uses a base encoding and an enhancement encoding. The video coding systems described herein operate upon a received decoding of a base encoding (e.g., frame-by-frame or complete base encoding) and add one or more of spatial, temporal, or other quality enhancements via an enhancement layer. The base encoding may be generated by a base layer, which may use a coding scheme that differs from the enhancement layer, and in certain cases may comprise a legacy or comparative (e.g., older) coding standard.

FIGS. 5 to 7 show a spatially scalable coding scheme that uses a down-sampled source signal encoded with a base codec, adds a first level of correction or enhancement data to the decoded output of the base codec to generate a corrected picture, and then adds a further level of correction or enhancement data to an up-sampled version of the corrected picture. Thus, the spatially scalable coding scheme may generate an enhancement stream with two spatial resolutions (higher and lower), which may be combined with a base stream at the lower spatial resolution.

In the spatially scalable coding scheme, the methods and apparatuses may be based on an overall algorithm which is built over an existing encoding and/or decoding algorithm (e.g., MPEG standards such as AVC/H.264, HEVC/H.265, etc. as well as non-standard algorithms such as VP9, AV1, and others) which works as a baseline for an enhancement layer. The enhancement layer works accordingly to a different encoding and/or decoding algorithm. The idea behind the overall algorithm is to encode/decode hierarchically the video frame as opposed to using block-based approaches as done in the MPEG family of algorithms. Hierarchically encoding a frame includes generating residuals for the full frame, and then a reduced or decimated frame and so on.

FIG. 5 shows a system configuration for an example spatially scalable encoding system 500. The encoding process is split into two halves as shown by the dashed line. Each half may be implemented separately. Below the dashed line is a base level and above the dashed line is the enhancement level, which may usefully be implemented in software. The encoding system 500 may comprise only the enhancement level processes, or a combination of the base level processes and enhancement level processes as needed. The encoding system 500 topology at a general level is as follows. The encoding system 500 comprises an input I for receiving an input signal 501. The input I is connected to a down-sampler 505D. The down-sampler 505D outputs to a base encoder 520E at the base level of the encoding system 500. The down-sampler 505D also outputs to a residual generator 510-S. An encoded base stream is created directly by the base encoder 520E, and may be quantised and entropy encoded as necessary according to the base encoding scheme. The encoded base stream may be the base layer as described above, e.g. a lowest layer in a multi-layer coding scheme.

Above the dashed line is a series of enhancement level processes to generate an enhancement layer of a multi-layer coding scheme. In the present example, the enhancement layer comprises two sub-layers. In other example, one or more sub-layers may be provided. In FIG. 5, to generate an encoded sub-layer 1 enhancement stream, the encoded base stream is decoded via a decoding operation that is applied at a base decoder 520D. In preferred examples, the base decoder 520D may be a decoding component that complements an encoding component in the form of the base encoder 520E within a base codec. In other examples, the base decoding block 520D may instead be part of the enhancement level. Via the residual generator 510-S, a difference between the decoded base stream output from the base decoder 520D and the down-sampled input video is created (i.e., a subtraction operation 510-S is applied to a frame of the down-sampled input video and a frame of the decoded base stream to generate a first set of residuals). Here, residuals represent the error or differences between a reference signal or frame and a desired signal or frame. The residuals used in the first enhancement level can be considered as a correction signal as they are able to ‘correct’ a frame of a future decoded base stream. This is useful as this can correct for quirks or other peculiarities of the base codec. These include, amongst others, motion compensation algorithms applied by the base codec, quantisation and entropy encoding applied by the base codec, and block adjustments applied by the base codec.

In FIG. 5, the first set of residuals are transformed, quantised and entropy encoded to produce the encoded enhancement layer, sub-layer 1 stream. In FIG. 5, a transform operation 510-1 is applied to the first set of residuals; a quantisation operation 520-1 is applied to the transformed set of residuals to generate a set of quantised residuals; and, an entropy encoding operation 530-1 is applied to the quantised set of residuals to generate the encoded enhancement layer, sub-layer 1 stream (e.g., at a first level of enhancement). The quantisation operation 520-1 may use the quantisation parameters generated by the methods and apparatus described above. However, it should be noted that in other examples only the quantisation step 520-1 may be performed. Entropy encoding may not be used, or may optionally be used in addition to one or both of the transform step 510-1 and quantisation step 520-1. The entropy encoding operation can be any suitable type of entropy encoding, such as a Huffmann encoding operation or a run-length encoding (RLE) operation, or a combination of both a Huffmann encoding operation and a RLE operation (e.g., RLE then Huffmann or prefix encoding).

To generate the encoded enhancement layer, sub-layer 2 stream, a further level of enhancement information is created by producing and encoding a further set of residuals via residual generator 500-S. The further set of residuals are the difference between an up-sampled version (via up-sampler 505U) of a corrected version of the decoded base stream (the reference signal or frame), and the input signal 501 (the desired signal or frame).

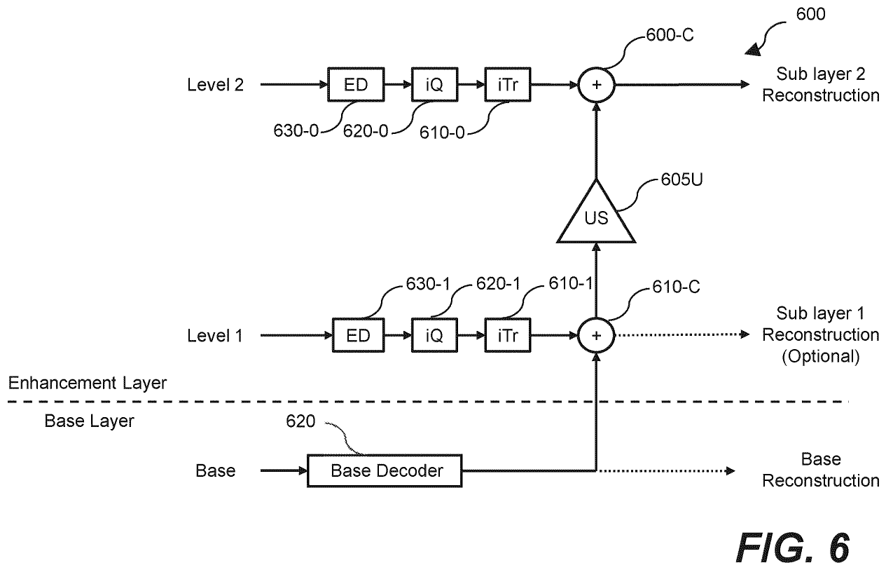

To achieve a reconstruction of the corrected version of the decoded base stream as would be generated at a decoder (e.g., as shown in FIG. 6), at least some of the sub-layer 1 encoding operations are reversed to mimic the processes of the decoder, and to account for at least some losses and quirks of the transform and quantisation processes. To this end, the first set of residuals are processed by a decoding pipeline comprising an inverse quantisation block 520-1i and an inverse transform block 510-1i. The quantised first set of residuals are inversely quantised at inverse quantisation block 520-1i and are inversely transformed at inverse transform block 510-1i in the encoding system 500 to regenerate a decoder-side version of the first set of residuals. The decoded base stream from decoder 520D is then combined with the decoder-side version of the first set of residuals (i.e., a summing operation 510-C is performed on the decoded base stream and the decoder-side version of the first set of residuals). Summing operation 510-C generates a reconstruction of the down-sampled version of the input video as would be generated in all likelihood at the decoder—i.e. a reconstructed base codec video). The reconstructed base codec video is then up-sampled by up-sampler 505U. Processing in this example is typically performed on a frame-by-frame basis. Each colour component of a frame may be processed as shown in parallel or in series.

The up-sampled signal (i.e., reference signal or frame) is then compared to the input signal 501 (i.e., desired signal or frame) to create the further set of residuals (i.e., a difference operation is applied by the residual generator 500-S to the up-sampled re-created frame to generate a further set of residuals). The further set of residuals are then processed via an encoding pipeline that mirrors that used for the first set of residuals to become an encoded enhancement layer, sub-layer 2 stream (i.e., an encoding operation is then applied to the further set of residuals to generate the encoded further enhancement stream). In particular, the further set of residuals are transformed (i.e., a transform operation 510-0 is performed on the further set of residuals to generate a further transformed set of residuals). The transformed residuals are then quantised, and entropy encoded in the manner described above in relation to the first set of residuals (i.e., a quantisation operation 520-0 is applied to the transformed set of residuals to generate a further set of quantised residuals; and, an entropy encoding operation 530-0 is applied to the quantised further set of residuals to generate the encoded enhancement layer, sub-layer 2 stream containing the further level of enhancement information). The quantisation operation 520-0 may use the quantisation parameters generated by the methods and apparatus described above. In certain cases, the operations may be controlled, e.g. such that, only the quantisation step 520-0 may be performed. Entropy encoding may optionally be used in addition. Preferably, the entropy encoding operation may be a Huffmann encoding operation or a run-length encoding (RLE) operation, or both (e.g., RLE then Huffmann encoding). The transformation applied at both blocks 510-1 and 510-0 may be a Hadamard transformation that is applied to 2×2 or 4×4 blocks of residuals.

The encoding operation in FIG. 5 does not result in dependencies between local blocks of the input signal (e.g., in comparison with many known coding schemes that apply inter or intra prediction to macroblocks and thus introduce macroblock dependencies). Hence, the operations shown in FIG. 5 may be performed in parallel on 4×4 or 2×2 blocks, which greatly increases encoding efficiency on multicore central processing units (CPUs) or graphical processing units (GPUs).

As illustrated in FIG. 5, the output of the spatially scalable encoding process is one or more enhancement streams for an enhancement layer which preferably comprises a first level of enhancement and a further level of enhancement. This is then combinable (e.g., via multiplexing or otherwise) with a base stream at a base level, e.g. into a MPEG2 transport stream or as multiple tracks within another digital container. The first level of enhancement (sub-layer 1) may be considered to enable a corrected video at a base level, that is, for example to correct for encoder quirks. The second level of enhancement (sub layer 2) may be considered to be a further level of enhancement that is usable to convert the corrected video to the original input video or a close approximation thereto. For example, the second level of enhancement may add fine detail that is lost during the downsampling and/or help correct from errors that are introduced by one or more of the transform operation 510-1 and the quantisation operation 520-1.

FIG. 6 shows a corresponding example decoding system 600 for the example spatially scalable coding scheme. In FIG. 6, the encoded base stream is decoded at base decoder 620 in order to produce a base reconstruction of the input signal 501. This base reconstruction may be used in practice to provide a viewable rendition of the signal 501 at the lower quality level. However, the primary purpose of this base reconstruction signal is to provide a base for a higher quality rendition of the input signal 501. To this end, the decoded base stream is provided for enhancement layer, sub-layer 1 processing (i.e., sub-layer 1 decoding). Sub-layer 1 processing in FIG. 6 comprises an entropy decoding process 630-1, an inverse quantisation process 620-1, and an inverse transform process 610-1. Optionally, only one or more of these steps may be performed depending on the operations carried out at corresponding block 500-1 at the encoder. By performing these corresponding steps, a decoded enhancement layer, sub-layer 1 stream comprising the first set of residuals is made available at the decoding system 600. The first set of residuals is combined with the decoded base stream from base decoder 620 (i.e., a summing operation 610-C is performed on a frame of the decoded base stream and a frame of the decoded first set of residuals to generate a reconstruction of the down-sampled version of the input video-i.e. the reconstructed base codec video). A frame of the reconstructed base codec video is then up-sampled by up-sampler 605U.

Additionally, and optionally in parallel, the encoded enhancement layer, sub-layer 2 stream is processed to produce a decoded further set of residuals. Similar to sub-layer 1 processing, enhancement layer, sub-layer 2 processing comprises an entropy decoding process 630-0, an inverse quantisation process 620-0 and an inverse transform process 610-0. Of course, these operations will correspond to those performed at block 500-0 in encoding system 500, and one or more of these steps may be omitted as necessary. Block 600-0 produces a decoded enhancement layer, sub-layer 2 stream comprising the further set of residuals, and these are summed at operation 600-C with the output from the up-sampler 605U in order to create an enhancement layer, sub-layer 2 reconstruction of the input signal 501, which may be provided as the output of the decoding system 600. Thus, as illustrated in FIGS. 5 and 6, the output of the decoding process may comprise up to three outputs: a base reconstruction, a corrected lower resolution signal and an original signal reconstruction for the multi-layer coding scheme at a higher resolution.

In general, examples described herein operate within encoding and decoding pipelines that comprises at least a transform operation. The transform operation may comprise the DCT or a variation of the DCT, a Fast Fourier Transform (FFT), or, in preferred examples, a Hadamard transform as implemented by LCEVC. The transform operation may be applied on a block-by-block basis. For example, an input signal may be segmented into a number of different consecutive signal portions or blocks and the transform operation may comprise a matrix multiplication (i.e., linear transformation) that is applied to data from each of these blocks (e.g., as represented by a 1D vector). In this description and in the art, a transform operation may be said to result in a set of values for a predefined number of data elements, e.g. representing positions in a resultant vector following the transformation. These data elements are known as transformed coefficients (or sometimes simply “coefficients”).

As described herein, where the enhancement data comprises residual data, a reconstructed set of coefficient bits may comprise transformed residual data, and a decoding method may further comprise instructing a combination of residual data obtained from the further decoding of the reconstructed set of coefficient bits with a reconstruction of the input signal generated from a representation of the input signal at a lower level of quality to generate a reconstruction of the input signal at a first level of quality. The representation of the input signal at a lower level of quality may be a decoded base signal and the decoded base signal may be optionally upscaled before being combined with residual data obtained from the further decoding of the reconstructed set of coefficient bits, the residual data being at a first level of quality (e.g., a first resolution). Decoding may further comprise receiving and decoding residual data associated with a second sub-layer, e.g. obtaining an output of the inverse transformation and inverse quantisation component, and combining it with data derived from the aforementioned reconstruction of the input signal at the first level of quality. This data may comprise data derived from an upscaled version of the reconstruction of the input signal at the first level of quality, i.e. an upscaling to the second level of quality.

Further details and examples of a two sub-layer enhancement encoding and decoding system may be obtained from published LCEVC documentation. Although examples have been described with reference to a tier-based hierarchical coding scheme in the form of LCEVC, the methods described herein may also be applied to other tier-based hierarchical coding scheme, such as VC-6: SMPTE VC-6 ST-2117 as described in PCT/GB2018/053552 and/or the associated published standard document.

FIG. 7 shows an example 700 of how a video signal may be decomposed into different components and then encoded. In the example of FIG. 7, a video signal 702 is encoded. The video signal 702 comprises a plurality of frames or pictures 704, e.g. where the plurality of frames represent action over time. In this example, each frame 704 is made up of three colour components. The colour components may be in any known colour space. In FIG. 7, the three colour components 706 are Y (luma), U (a first chroma opponent colour) and V (a second chroma opponent colour). Each colour component may be considered a plane 708 of values. The plane 708 may be decomposed into a set of n by n blocks of signal data 710. For example, in LCEVC, n may be 2 or 4; in other video coding technologies n may be 8 to 32.

In LCEVC and certain other coding technologies, a video signal fed into a base layer is a downscaled version of the input video signal, e.g. 501. In this case, the signal that is fed into both sub-layers of the enhancement layer comprises a residual signal comprising residual data. A plane of residual data may also be organised in sets of n-by-n blocks of signal data 710. The residual data may be generated by comparing data derived from the input signal being encoded, e.g. the video signal 501, and data derived from a reconstruction of the input signal, the reconstruction of the input signal being generated from a representation of the input signal at a lower level of quality. The comparison may comprise subtracting the reconstruction from the downsampled version. The comparison may be performed on a frame-by-frame (and/or block-by-block) basis. The comparison may be performed at the first level of quality; if the base level of quality is below the first level of quality, a reconstruction from the base level of quality may be upscaled prior to the comparison. In a similar manner, the input signal to the second sub-layer, e.g. the input for the second sub-layer transformation and quantisation component, may comprise residual data that results from a comparison of the input video signal 501 at the second level of quality (which may comprise a full-quality original version of the video signal) with a reconstruction of the video signal at the second level of quality. As before, the comparison may be performed on a frame-by-frame (and/or block-by-block) basis and may comprise subtraction. The reconstruction of the video signal may comprise a reconstruction generated from the decoded decoding of the encoded base bitstream and a decoded version of the first sub-layer residual data stream. The reconstruction may be generated at the first level of quality and may be upsampled to the second level of quality.

Hence, a plane of data 708 for the first sub-layer may comprise residual data that is arranged in n-by-n signal blocks 710. One such 2 by 2 signal block is shown in more detail in FIG. 7 (n is selected as 2 for ease of explanation) where for a colour plane the block may have values 712 with a set bit length (e.g., 8 or 16-bit). Each n-by-n signal block may be represented as a flattened vector 714 of length n2 representing the blocks of signal data. To perform the transform operation, the flattened vector 714 may be multiplied by a transform matrix 716 (i.e., the dot product taken). This then generates another vector 718 of length n2 representing different transformed coefficients for a given signal block 710. FIG. 7 shows an example similar to LCEVC where the transform matrix 716 is a Hadamard matrix of size 4 by 4, resulting in a transformed coefficient vector 718 having four elements with respective values. These elements are sometimes referred to by the letters A, H, V and D as they may represent an average, horizontal difference, vertical difference and diagonal difference. Such a transform operation may also be referred to as a directional decomposition. When n=4, the transform operation may use a 16 by 16 matrix and be referred to as a directional decomposition squared.

As shown in FIG. 7, the set of values for each data element across the complete set of signal blocks 710 for the plane 708 may themselves be represented as a plane or surface of coefficient values 720. For example, values for the “H” data elements for the set of signal blocks may be combined into a single plane, where the original plane 708 is then represented as four separate coefficient planes 722. For example, the illustrated coefficient plane 722 contains all the “H” values. These values are stored with a predefined bit length, e.g. a bit length B, which may be 8, 16, 32 or 64 depending on the bit depth. A 16-bit example is considered below but this is not limiting. As such, the coefficient plane 722 may be represented as a sequence (e.g., in memory) of 16-bit or 2-byte values 724 representing the values of one data element from the transformed coefficients. These may be referred to as coefficient bits. These coefficient bits may be quantised and then entropy encoded as discussed to then generate the encoded enhancement or second layer data as described above.

Certain clauses setting out claimed and unclaimed aspects of the present disclosure will now be briefly presented.

In one unclaimed aspect, a method of computing encoding parameters for an encoding of an input video, the method comprising: receiving an encoding quality factor indicating a desired visual quality for an encoding of the input video; mapping the encoding quality factor to a base quality factor indicating a desired visual quality for a base encoding of the input video, the base encoding providing an encoding at a first level of quality; obtaining, from a base encoder, base encoding parameters for the base quality factor; and mapping the base encoding parameters, the base quality factor, and the encoding quality factor to enhancement encoding parameters for an enhancement encoding, wherein a combination of the base encoding and the enhancement encoding provide an encoding at a second level of quality that is higher than the first level of quality.

In the above method, the encoding quality factor may be a constant rate factor for the combination of the base and enhancement encoding and the base quality factor may be a constant rate factor for the base encoding, the base encoding being performed in a constant rate factor mode. The encoding quality factor and the base quality factor may be constant for the encoding of the input video. The steps of obtaining the base encoding parameters and mapping the base encoding parameters to enhancement encoding parameters may be performed for each frame of the input video. The enhancement encoding may comprise a plurality of sublayers having different levels of quality. The method may further comprise: computing an enhancement quality factor as a function of the encoding quality factor and the base quality factor; modulating the enhancement quality factor based on the base encoding parameters; and mapping the modulated enhancement quality factor to quantisation parameters for each of the plurality of sublayers. The method may comprise mapping the modulated enhancement quality factor to quantisation step widths for each of the plurality of sublayers, and/or receiving the base quality factor, retrieving a set of coefficients based on the value of the base quality factor; and computing the enhancement quality factor as a non-linear function of the base quality factor and the encoding quality factor, the non-linear function being configured based on the set of coefficients.

In one case, the input video may be received at a first spatial resolution and the method may comprise, on a frame-by-frame basis: downsampling a current frame of the input video to create a downsampled frame at a second spatial resolution that is lower than the first spatial resolution; instructing the base encoding of the downsampled frame using the base encoder to create a base encoded stream; generating a reconstruction of the current frame at the second spatial resolution from a decoding of the base encoded stream; computing residual data for a first sublayer of the plurality of sublayers as a difference between the reconstruction of the current frame at the second spatial resolution and the downsampled current frame; encoding the residual data for the first sublayer using the quantisation step width for the first sublayer to generate encoded residual data for the first sublayer; combining a decoding of the encoded residual data for the first sublayer with the reconstruction of the current frame to generate a corrected reconstruction of the current frame; upsampling the corrected reconstruction of the current frame to the first spatial resolution; computing residual data for a second sublayer of the plurality of sublayers as a difference between the upsampled corrected reconstruction of the current frame and the current frame; and encoding the residual data for the second sublayer using the quantisation step width for the second sublayer to generate encoded residual data for the second sublayer.

The method may be applied on a frame-by-frame basis and the base encoding parameters may comprise one or more of: a frame type; a frame size in bits; and a quantisation metric for the frame. The frame type may indicate one of: an Intra—I—frame, a Predicted—P—frame, and a Bidirectional—B—frame; and the quantisation metric may be an average quantisation parameter—QP—for the frame.

Mapping the encoding quality factor and mapping the base encoding parameters may comprise using one or more look-up tables and/or using one or more trained neural network architectures. Mapping the encoding quality factor to the base quality factor may comprise: determining a base encoding type, the base encoding type being selected from a plurality of different available base encoding types based on the base encoder used for the base encoding; and configuring a mapping for the determined base encoding type. Mapping the base encoding parameters, the base quality factor, and the encoding quality factor to enhancement encoding parameters may comprise: mapping a plurality of base encoding parameters, the base quality factor, and the encoding quality factor to quantisation step-widths and estimated bit rate parameters for the enhancement encoding.

The method may comprise, for a given frame: determining a range of available bit per pixel values for the enhancement encoding; obtaining a set of encoding settings based on an encoding of a previous frame; using the range of available bit per pixel values and the set of encoding settings to adjust the enhancement encoding parameters; and repeating the method with the adjusted enhancement encoding parameters prior to encoding. Determining the range of available bit per pixel values for the enhancement encoding may comprise: determining a first range of available bit per pixel values based on a set of encoding parameters; determining a second range of available bit per pixel values based on a buffer arranged to store encoded bits from the base and enhancement encodings; and outputting minimum and maximum bit per pixel values as constrained by the first and second ranges.

In one aspect described herein, where a “charging” mode is used, a method of computing encoding parameters for an encoding of an input video is provided. The method comprises: obtaining an encoding quality factor for encoding a current frame of data for at least one layer of an enhancement encoding, the current frame of data comprising residual data computed as a difference between an original frame of the input video and a reconstruction of the original frame, the reconstruction of the original frame being generated from a decoding of a base encoding; and selectively modulating the encoding quality factor based on characteristics of the input video to output a modulated encoding quality factor, the modulated encoding quality factor being used to determine quantisation parameters for encoding the current frame of data, wherein selectively modulating the encoding quality factor comprises: determining a ratio of static image portions to non-static image portions for the current frame of data; and modulating the encoding quality factor based on the ratio to lower a quantisation step width responsive to a presence of static image portions.

In one example, the encoding quality factor is selectively modulated for frames that are indicated as temporal reference frames. Determining a ratio of static image portions to non-static image portions for the current frame of data may comprise: computing an intra-frame data metric for each of a set of coding units for the current frame of data; computing an inter-frame data metric for each of a set of coding units for the current frame of data; and comparing the intra-frame and inter-frame data metrics to respective thresholds to classify each of the set of coding units based on intra-frame and inter-frame variation.

In one example, the method comprises: determining a baseline of modulation based on the ratio of static image portions to non-static image portions for the current frame of data; smoothing the baseline of modulation based on the ratio of static image portions to non-static image portions for the current frame of data; and using the smoothed baseline to adjust the obtained encoding quality factor.

In one aspect described herein, where an “accurate” mode is used, a method of computing encoding parameters for an encoding of an input video is provided. The method comprises: obtaining an encoding quality factor; using the encoding quality factor to encode a current frame of data for at least one layer of an enhancement encoding, the current frame of data comprising residual data computed as a difference between an original frame of the input video and a reconstruction of the original frame, the reconstruction of the original frame being generated from a decoding of a base encoding; obtaining an encoding bit rate metric for the encoding of the current frame of data; comparing the encoding bit rate metric to a threshold to detect a change in video content complexity; and based on the result of the comparison, selectively recomputing the encoding quality factor and reperforming the encoding of the current frame of data with the recomputed encoding quality factor.

In one example, selectively recomputing the encoding quality factor comprises one or more of adjusting and scaling the obtained encoding quality factor. The method may further comprise: obtaining a target bit rate metric for the current frame of data; determining an overshoot as a ratio of the encoding and target bit rate metrics; comparing the overshoot to the threshold; and recomputing the encoding quality factor responsive to the overshoot being greater than the threshold. In one case, the scaling is computed based on the overshoot.

In one example, the method comprises: obtaining a multipass flag; and selectively recomputing the encoding quality factor and reperforming the encoding responsive to the multipass flag being positive and the threshold being exceeded. The re-computation of the encoding quality factor may be adjusted based on whether the current frame of data has undergone a pre-encoding prioritisation operation.

An encoder may be adapted to perform the method of any of the aspects described above. A computer program may also be provided, comprising instructions which, when the program is executed by a computer, cause the computer to carry out any one of said methods. The computer program may be carried on a non-transitory computer-readable medium. An enhancement bit stream may be encoded using the enhancement encoding parameters as computed by any one of the methods described herein. A decoder may be configured to decode the enhancement bit stream of claim 19 and to combine an output of said decoding with a decoding of the base encoding to generate a reconstruction of the input video.

Certain methods and encoder components as described herein may be performed by instructions that are stored upon a non-transitory computer readable medium. The non-transitory computer readable medium stores code comprising instructions that, if executed by one or more computers, would cause the computer to perform steps of methods or execute operations of encoder components as described herein. The non-transitory computer readable medium may comprise one or more of a rotating magnetic disk, a rotating optical disk, a flash random access memory (RAM) chip, and other mechanically moving or solid-state storage media. Some examples may be implemented as: physical devices such as semiconductor chips; hardware description language representations of the logical or functional behaviour of such devices; and one or more non-transitory computer readable media arranged to store such hardware description language representations. Descriptions herein reciting principles, aspects, and embodiments encompass both structural and functional equivalents thereof.

Patent and non-patent documents that are referenced herein are deemed to be incorporated by reference into the present document.

Certain examples have been described herein and it will be noted that different combinations of different components from different examples may be possible. Salient features are presented to better explain examples; however, it is clear that certain features may be added, modified and/or omitted without modifying the functional aspects of these examples as described. Elements described herein as “coupled” or “communicatively coupled” have an effectual relationship realizable by a direct connection or indirect connection, which uses one or more other intervening elements. Examples described herein as “communicating” or “in communication with” another device, module, or elements include any form of communication or link. Furthermore, equivalents and modifications not described above may also be employed without departing from the scope of the invention, which is defined in the accompanying claims.

1. A method of computing encoding parameters for an encoding of an input video, the method comprising:
receiving an encoding quality factor indicating a desired visual quality for an encoding of the input video;
mapping the encoding quality factor to a base quality factor indicating a desired visual quality for a base encoding of the input video, the base encoding providing an encoding at a first level of quality;
obtaining, from a base encoder, base encoding parameters for the base quality factor; and
mapping the base encoding parameters, the base quality factor, and the encoding quality factor to enhancement encoding parameters for an enhancement encoding, wherein a combination of the base encoding and the enhancement encoding provide an encoding at a second level of quality that is higher than the first level of quality.

2. The method of claim 1, wherein the encoding quality factor is a constant rate factor for the combination of the base and enhancement encoding and the base quality factor is a constant rate factor for the base encoding, the base encoding being performed in a constant rate factor mode.

3. The method of claim 2, wherein the encoding quality factor and the base quality factor are constant for the encoding of the input video, and wherein the steps of obtaining the base encoding parameters and mapping the base encoding parameters to enhancement encoding parameters are performed for each frame of the input video.

4. The method of claim 3, wherein the enhancement encoding comprises a plurality of sublayers having different levels of quality, and the method further comprises:
computing an enhancement quality factor as a function of the encoding quality factor and the base quality factor;
modulating the enhancement quality factor based on the base encoding parameters; and
mapping the modulated enhancement quality factor to quantisation parameters for each of the plurality of sublayers.

5. The method of claim 4, wherein the method comprises:
mapping the modulated enhancement quality factor to quantisation step widths for each of the plurality of sublayers.

6. The method of claim 5, comprising:
receiving the base quality factor;
retrieving a set of coefficients based on the value of the base quality factor; and
computing the enhancement quality factor as a non-linear function of the base quality factor and the encoding quality factor, the non-linear function being configured based on the set of coefficients.

7. The method of claim 5 or claim 6, wherein the input video is received at a first spatial resolution and the method comprises, on a frame-by-frame basis:
downsampling a current frame of the input video to create a downsampled frame at a second spatial resolution that is lower than the first spatial resolution;
instructing the base encoding of the downsampled frame using the base encoder to create a base encoded stream;
generating a reconstruction of the current frame at the second spatial resolution from a decoding of the base encoded stream;
computing residual data for a first sublayer of the plurality of sublayers as a difference between the reconstruction of the current frame at the second spatial resolution and the downsampled current frame;
encoding the residual data for the first sublayer using the quantisation step width for the first sublayer to generate encoded residual data for the first sublayer;
combining a decoding of the encoded residual data for the first sublayer with the reconstruction of the current frame to generate a corrected reconstruction of the current frame;
upsampling the corrected reconstruction of the current frame to the first spatial resolution;
computing residual data for a second sublayer of the plurality of sublayers as a difference between the upsampled corrected reconstruction of the current frame and the current frame; and
encoding the residual data for the second sublayer using the quantisation step width for the second sublayer to generate encoded residual data for the second sublayer.

8. The method of any one of claims 1 to 7, wherein the method is applied on a frame-by-frame basis and the base encoding parameters comprise:
a frame type;
a frame size in bits; and
a quantisation metric for the frame.

9. The method of claim 8, wherein:
the frame type indicates one of: an Intra—I—frame, a Predicted—P—frame, and a Bidirectional—B—frame; and
the quantisation metric is an average quantisation parameter—QP—for the frame.

10. The method of any one of claims 1 to 9, wherein mapping the encoding quality factor and mapping the base encoding parameters comprises using one or more look-up tables.

11. The method of any one of claims 1 to 10, wherein mapping the encoding quality factor and mapping the base encoding parameters comprises using one or more trained neural network architectures.

12. The method of any one of claims 1 to 11, wherein mapping the encoding quality factor to the base quality factor comprises:
determining a base encoding type, the base encoding type being selected from a plurality of different available base encoding types based on the base encoder used for the base encoding; and
configuring a mapping for the determined base encoding type.

13. The method of any one of claims 1 to 12, wherein mapping the base encoding parameters, the base quality factor, and the encoding quality factor to enhancement encoding parameters comprises:
mapping a plurality of base encoding parameters, the base quality factor, and the encoding quality factor to quantisation step-widths and estimated bit rate parameters for the enhancement encoding.

14. The method of claim 6 or claim 7, further comprising, for a given frame:
determining a range of available bit per pixel values for the enhancement encoding;
obtaining a set of encoding settings based on an encoding of a previous frame;
using the range of available bit per pixel values and the set of encoding settings to adjust the enhancement encoding parameters; and
repeating the method with the adjusted enhancement encoding parameters prior to encoding.

15. The method of claim 14, wherein determining the range of available bit per pixel values for the enhancement encoding comprises:
determining a first range of available bit per pixel values based on a set of encoding parameters;
determining a second range of available bit per pixel values based on a buffer arranged to store encoded bits from the base and enhancement encodings; and
outputting minimum and maximum bit per pixel values as constrained by the first and second ranges.

16. An encoder adapted to perform the method of any one of claims 1 to 15.

17. A computer program comprising instructions which, when the program is executed by a computer, cause the computer to carry out the method of any one of claims 1 to 15.

18. A non-transitory computer-readable medium comprising the computer program of claim 17.

19. An enhancement bit stream encoded using the enhancement encoding parameters as computed by the method of any one of claims 1 to 15.

20. A decoder configured to decode the enhancement bit stream of claim 19 and to combine an output of said decoding with a decoding of the base encoding to generate a reconstruction of the input video.

21. A method of computing encoding parameters for an encoding of an input video, the method comprising:
obtaining an encoding quality factor for encoding a current frame of data for at least one layer of an enhancement encoding, the current frame of data comprising residual data computed as a difference between an original frame of the input video and a reconstruction of the original frame, the reconstruction of the original frame being generated from a decoding of a base encoding; and
selectively modulating the encoding quality factor based on characteristics of the input video to output a modulated encoding quality factor, the modulated encoding quality factor being used to determine quantisation parameters for encoding the current frame of data,
wherein selectively modulating the encoding quality factor comprises:
determining a ratio of static image portions to non-static image portions for the current frame of data; and
modulating the encoding quality factor based on the ratio to lower a quantisation step width responsive to a presence of static image portions.

22. The method of claim 21, wherein the encoding quality factor is selectively modulated for frames that are indicated as temporal reference frames.

23. The method of claim 21 or claim 22, wherein determining a ratio of static image portions to non-static image portions for the current frame of data comprises:
computing an intra-frame data metric for each of a set of coding units for the current frame of data;
computing an inter-frame data metric for each of a set of coding units for the current frame of data; and
comparing the intra-frame and inter-frame data metrics to respective thresholds to classify each of the set of coding units based on intra-frame and inter-frame variation.

24. The method of any one of claims 21 to 23, comprising:
determining a baseline of modulation based on the ratio of static image portions to non-static image portions for the current frame of data;
smoothing the baseline of modulation based on the ratio of static image portions to non-static image portions for the current frame of data; and
using the smoothed baseline to adjust the obtained encoding quality factor.

25. A method of computing encoding parameters for an encoding of an input video, the method comprising:
obtaining an encoding quality factor;
using the encoding quality factor to encode a current frame of data for at least one layer of an enhancement encoding, the current frame of data comprising residual data computed as a difference between an original frame of the input video and a reconstruction of the original frame, the reconstruction of the original frame being generated from a decoding of a base encoding;
obtaining an encoding bit rate metric for the encoding of the current frame of data;
comparing the encoding bit rate metric to a threshold to detect a change in video content complexity; and
based on the result of the comparison, selectively recomputing the encoding quality factor and reperforming the encoding of the current frame of data with the recomputed encoding quality factor.

26. The method of claim 25, wherein selectively recomputing the encoding quality factor comprises one or more of adjusting and scaling the obtained encoding quality factor.

27. The method of claim 26, comprising:
obtaining a target bit rate metric for the current frame of data;
determining an overshoot as a ratio of the encoding and target bit rate metrics;
comparing the overshoot to the threshold; and
recomputing the encoding quality factor responsive to the overshoot being greater than the threshold.

28. The method of claim 27, wherein the scaling is computed based on the overshoot.

29. The method of any one of claims 25 to 28, comprising:
obtaining a multipass flag; and
selectively recomputing the encoding quality factor and reperforming the encoding responsive to the multipass flag being positive and the threshold being exceeded.

30. The method of any one of claims 25 to 29, wherein the re-computation of the encoding quality factor is adjusted based on whether the current frame of data has undergone a pre-encoding prioritisation operation.

31. An encoder adapted to perform the method of any one of claims 21 to 30.

32. A computer program comprising instructions which, when the program is executed by a computer, cause the computer to carry out the method of any one of claims 21 to 30.

33. A non-transitory computer-readable medium comprising the computer program of claim 32.

34. An enhancement bit stream encoded using the enhancement encoding parameters as computed by the method of any one of claims 21 to 30.

35. A decoder configured to decode the enhancement bit stream of claims 34 and to 10 combine an output of said decoding with a decoding of the base encoding to generate a reconstruction of the input video.
